(19) United States
(12) Patent Application Publication
(10) Pub. No.: US 2015/0149337 A1
(43) Pub. Date: May 28, 2015

(54) APPARATUS, METHOD, SYSTEM, AND STORAGE MEDIUM

(71) Applicant: FUJITSU LIMITED, Kawasaki-shi (JP)

(72) Inventor: Yuji NISHIYAMA, Fukuoka (JP)

(73) Assignee: FUJITSU LIMITED, Kawasaki-shi (JP)

(21) Appl. No.: 14/546,495

(22) Filed: Nov. 18, 2014

(30) Foreign Application Priority Data
Nov. 28, 2013 (JP) 2013-246627

(51) Int. Cl. G06Q 20/14

(52) U.S. Cl. CPC G06Q 20/14
USPC 705/35

(57) ABSTRACT

An apparatus of outputting notification data, the apparatus includes: a first memory configured to store a history of contact with customer in association with identification information of the customer; and a processor coupled to the memory and configured to: read the history associated with the identification information from the first memory, specify the customer who meets a predetermined condition in the content of the read history, and generate notification data to the specified customer.

### CROSS-REFERENCE TO RELATED APPLICATION

This application is based upon and claims the benefit of priority from the prior Japanese Patent Application No. 2013-246627, filed on Nov. 28, 2013, the entire contents of which are incorporated herein by reference.

### FIELD

The embodiments discussed herein are related to a technique of specifying a customer to be notified of a payment and outputting notification data to the specified customer.

### BACKGROUND

As a part of a loan business which is performed in financial institutions, work of notifying a customer in arrears of repayment has been carried out. This payment notification work is performed by an operator of a call center who contacts the customer through telephone communication. In addition, as a method of payment notification, the financial institutions send a reminder to the customer.

For example, it is known to provide various information to the customer using a terminal device such as an automated teller machine (ATM) or a cash dispenser (CD).

However, in a case where the customer is absent or not at home, the financial institutions are not able to communicate with the customer by a telephone at home. Even when the financial institutions try to contact the mobile phone carried by the customer, the customer may not take the mobile phone because of a state where the costumer is not able to answer the phone or the customer pretends to be out. Therefore, it is difficult to say that the financial institutions are able to reliably contact the customer. Even when a reminder is delivered to a customer's house, it is not possible for the financial institutions to confirm whether or not the customer has opened the reminder and has read the content thereof.

In the payment notification work, it is desired to reliably notify the customer about the payment and store a record indicating that the notification is recognized by the customer. If there is no record indicating that the customer is notified about the payment, it is difficult for the financial institutions to take a legal action to the customer who does not perform repayment.

Thus, the financial institutions have to use an alternative method to contact the customer who does not respond to the reminder (document) or calls (telephone communication).

Japanese Patent No. 5043255 and Japanese Laid-open Patent Publication No. 10-27207 are known as related arts for example.

### SUMMARY

According to an aspect of the invention, an apparatus of outputting notification data, the apparatus includes: a first memory configured to store a history of contact with customer in association with identification information of the customer; and a processor coupled to the memory and configured to: read the history associated with the identification information from the first memory, specify the customer who meets a predetermined condition in the content of the read history, and generate notification data to the specified customer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration of a payment notification system;

FIG. 2 illustrates an example of a configuration of hardware of a call center server included in a call center system;

FIG. 3 illustrates an example of a record layout of a debtor DB;

FIG. 4 illustrates an example of a record layout of a loan DB;

FIG. 5 illustrates an example of a record layout of a negotiation history DB;

FIG. 6 illustrates an example of a record layout of an ATM notification determination DB;

FIG. 7 illustrates an example of a record layout of a template DB;

FIG. 8 illustrates an example of a record layout of a message DB;

FIG. 9 illustrates an example of a record layout of an operator DB;

FIG. 10 illustrates an example of a configuration of hardware of an accounting server included in an accounting system;

FIG. 11 illustrates an example of a record layout of a deposit and withdrawal history DB;

FIG. 12 illustrates an example of a configuration of hardware of an ATM device;

FIG. 13 is a flowchart illustrating an example of a procedure of a notification process;

FIG. 14 is a flowchart illustrating an example of a procedure of a case determination process;

FIG. 15 is a flowchart illustrating an example of a procedure of a message generating process;

FIG. 16 is a flowchart illustrating an example of a procedure of a message displaying process;

FIG. 17 illustrates an example of a display unit on which a message is displayed in an ATM device;

FIG. 18 is a flowchart illustrating an example of a procedure of a synchronous process;

FIGS. 19A, 19B, 19C, 19D, 19E and 19F illustrate an example of a screen displayed on an operator terminal in a call center;

FIG. 20 illustrates an example of a display unit on which a message is displayed in an ATM device;

FIG. 21 illustrates an example of a display unit on which a message is displayed in an ATM device;

FIG. 22 illustrates an example of a record layout of an ATM notification determination DB according to a second embodiment;

FIG. 23 illustrates an example of a record layout of an absence determination correction DB according to a third embodiment;

FIGS. 24, 25A and 25B illustrate an example of a screen displayed on an operator terminal in a call center according to a fourth embodiment;

FIG. 26 illustrates an example of a functional composition of a call center server;

FIG. 27 illustrates an example of a functional composition of an ATM device; and

FIG. 28 illustrates an example of a configuration of a payment notification system according to a fifth embodiment.

### DESCRIPTION OF EMBODIMENTS

The present invention was made in consideration of the above described circumstance, and an object thereof is to provide a method of specifying a customer to be notified and then notifying the customer about payment based on history relating to contact with a customer to be notified about payment.

Hereinafter, a payment notification system disclosed in the present application will be described with reference to the drawings.

First Embodiment

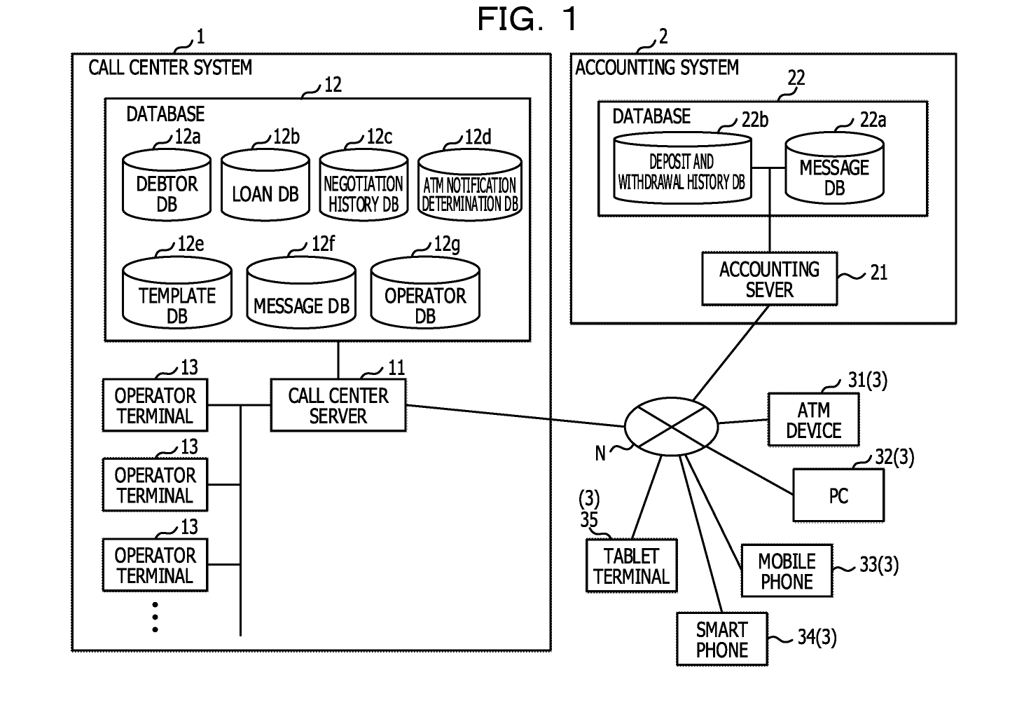

FIG. 1 illustrates an example of a configuration of a payment notification system. The payment notification system includes a call center system 1, an accounting system 2, a terminal device 3, and a network N coupling the call center system 1, the accounting system 2 and the terminal device 3.

The call center system 1 is a system in which mainly; an operator notifies customers who are in arrears with payment about the payment on the phone. The accounting system 2 performs an information process relating to a transaction between a customer and a bank. This transaction is performed via the terminal device 3. The terminal device 3 is a terminal used in a case where the customer performs the transaction with the bank.

The call center system 1 includes a call center server 11, a database 12, and an operator terminal 13. The call center server 11 is an example of a notification data generating apparatus. The accounting system 2 includes an accounting server 21 and a database 22. The terminal device 3 is, for example, an ATM device 31, a personal computer (PC) 32, a mobile phone 33, a smart phone 34, or a tablet terminal 35.

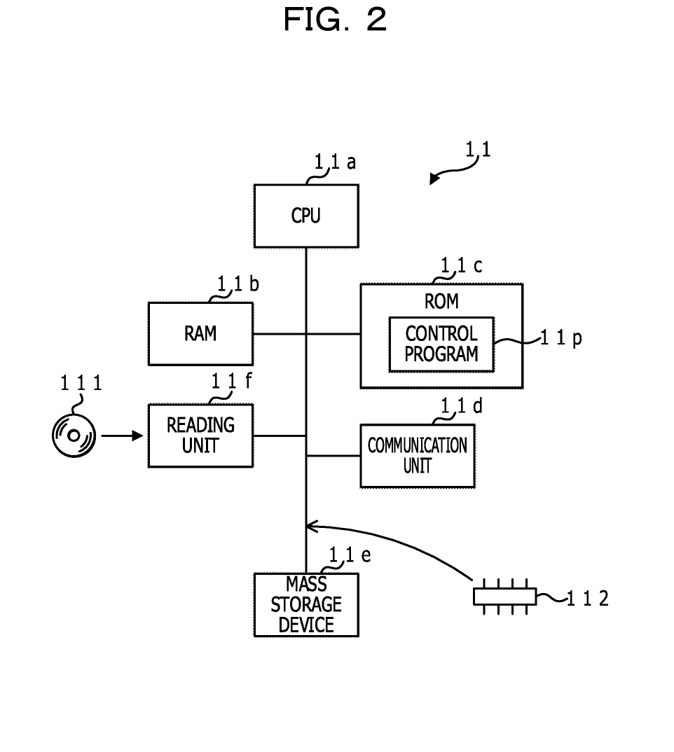

FIG. 2 illustrates an example of a configuration of hardware of the call center server 11 included in the call center system 1. The call center server 11 includes a central processing unit (CPU) 11a, a random access memory (RAM) 11b, a read only memory (ROM) 11c, a communication unit 11d, a mass storage device 11e, and a reading unit 11f. These components are coupled to each other via a bus. The CPU 11a controls each hardware unit according to a control program 11p stored in the ROM 11c. The RAM 11b is, for example, an static RAM (SRAM), a dynamic RAM (DRAM), or a flash memory. The RAM 11b temporarily stores data generated when performing a program by the CPU 11a. The communication unit 11d has a function of communicating with the accounting server 21 via the network N. The mass storage device 11e is, for example, a hard disk or a solid state drive (SSD). The mass storage device 11e temporarily stores data to be stored in the database 12. In addition, the mass storage device 11e may be set to store the control program 11p.

The reading unit 11f reads a portable storage medium 111. A compact disk ROM (CD-ROM) and a digital versatile disc ROM (DVD-ROM) are examples of the portable storage medium 111. The CPU 11a may read the control program 11p from the portable storage medium 111 via the reading unit 11f and store the control program 11p in the mass storage device 11e. In addition, the CPU 11a may download the control program 11p from another computer via the network N and store the control program 11p in the mass storage device 11e. The CPU 11a may read the control program 11p from a semiconductor memory 112.

Next, data stored in the database 12 of the call center system 1 will be described. The database 12 stores a debtor data base (DB) 12a, a loan DB 12b, a negotiation history DB 12c (the history storage unit), an ATM notification determination DB 12d, a template DB 12e (the model storage unit), a message DB 12f (the notification data storage unit), and an operator DB 12g. The negotiation history DB 12c is an example of the history storage unit. The template DB 12e is an example of the model storage unit. The message DB 12f is an example of the notification data storage unit.

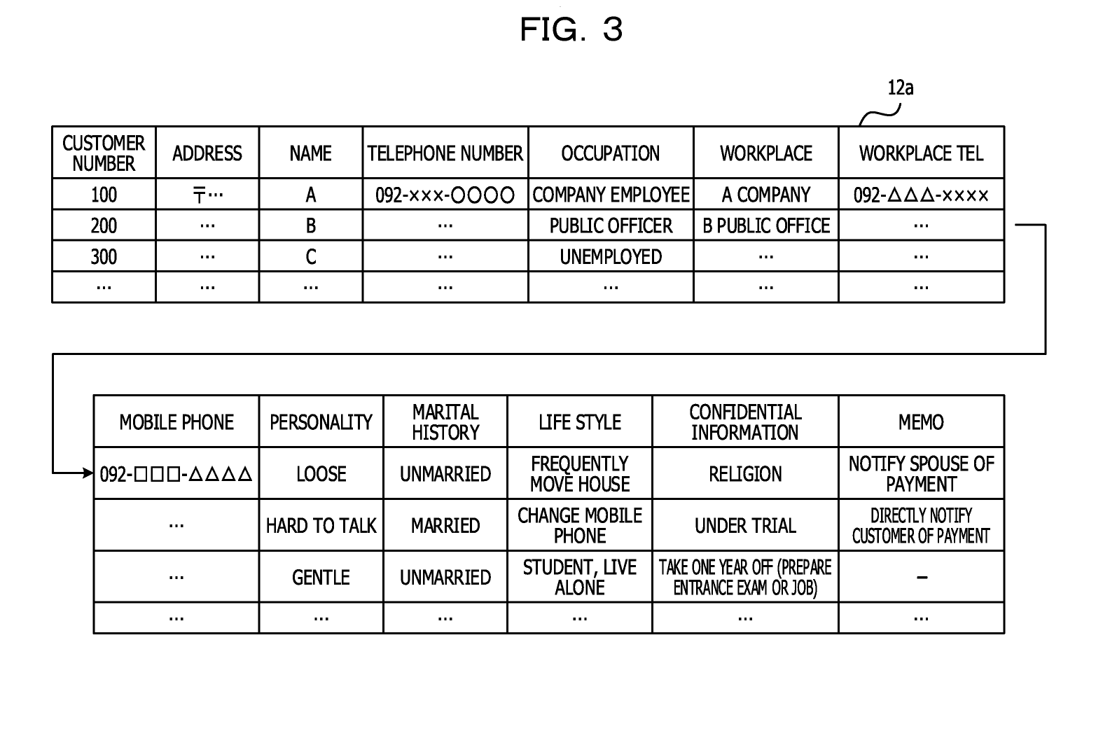

FIG. 3 illustrates an example of a record layout of the debtor DB 12a. The debtor DB 12a includes a customer number column, an address column, a name column, a telephone number column, an occupation column, a workplace column, a workplace TEL column, a mobile phone column, a personality column, a marital history column, a life style column, a confidential information column, and a memo column. The customer number column stores a number for univocally specifying a customer. The address column stores a house address of the customer. The name column stores the customer's kanji name. The telephone number column stores a telephone number of the customer. The occupation column stores an occupation of the customer. The workplace column stores a name of the customer's workplace. The workplace TEL column stores a telephone number of the customer's workplace. The mobile phone column stores a mobile phone number of the customer. The personality column stores the personality of the customer. An operator grasps the personality of the customer through telephone communication and then the personality of the customer is stored in the personality column. The marital history column stores a marital history (unmarried, married, and widowed) of the customer. The life style column stores the customer's life style. The information of life style is obtained through documents of a loan examination or telephone communication with the operator and then stored in the life style column. The confidential information column stores confidential information regarding the customer. The confidential information is related to social status, for example, religious beliefs, a dispute or a lawsuit, or taking one year off for some reason. The memo column stores the information for sharing among operators.

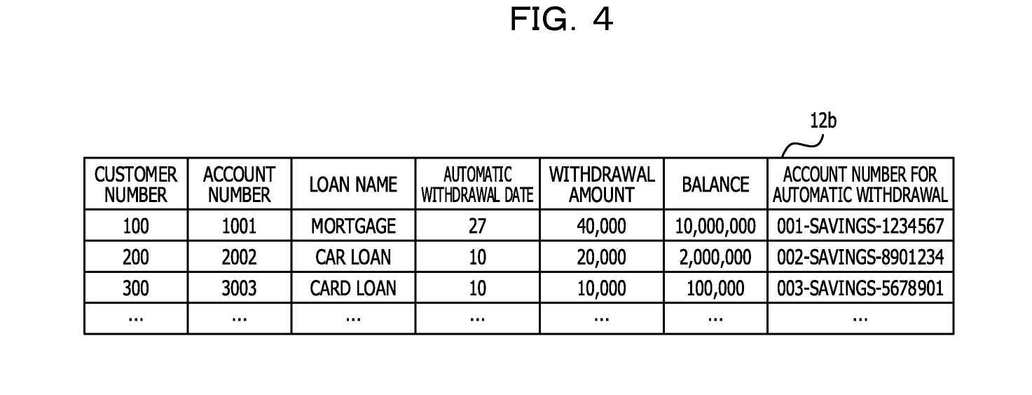

FIG. 4 illustrates an example of the record layout of the loan DB 12b. The loan DB 12b includes a customer number column, an account number column, a loan name column, an automatic withdrawal date column, an automatic withdrawal amount column, a balance column, an account number for automatic withdrawal column. The customer number column stores the customer number. The account number column stores the account number for univocally specifying a loan account of the customer. The automatic withdrawal date column stores the date when the monthly automatic withdrawal is performed from the account for automatic withdrawal. The withdrawal amount column stores an amount of monthly automatic withdrawal from the account. The amount of automatic withdrawal means an amount of monthly repayment. The balance column stores a balance of repayment. The account number for automatic withdrawal column stores the account number where the money for monthly repayment is withdrawn.

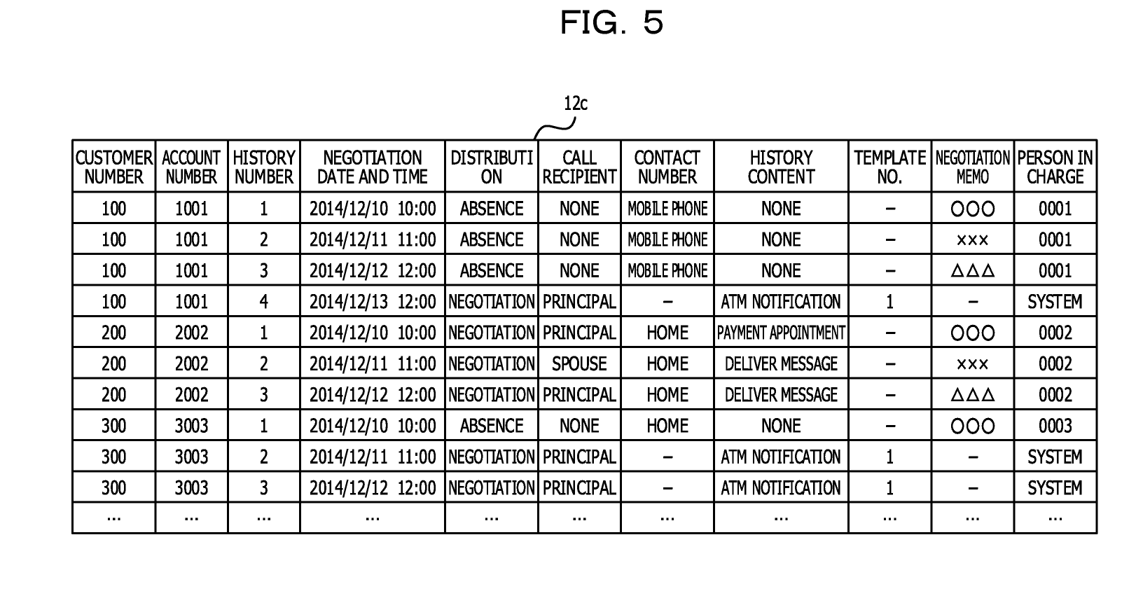

FIG. 5 illustrates an example of the record layout of the negotiation history DB 12c. The negotiation history DB 12c includes a customer number column, an account number column, a history number column, a negotiation date and time column, a distribution column, a call recipient column, a call destination column, a history content column, a template No. column, a negotiation memo column, and a person in charge column. The customer number column stores the customer number of the customer that the person in charge conducted negotiations or tried to conduct negotiations with. The account number column stores the loan account number to be managed. The history number column stores numbers of the negotiation history in order. The negotiation date and time column stores the date and time when the person in charge conducted negotiations or tried to conduct negotiations with the customer. The distribution column stores the fact of negotiation between the person in charge and the call recipient. For example, in a case where the person in charge conducts negotiations with the call recipient, “negotiation” is stored in the distribution column. In a case where the person in charge does not conduct negotiations with the call recipient due to the absence of the call recipient, “absence” is stored in the distribution column. The call recipient column stores the information of the person (the call recipient) who talked with the person in charge on the phone. For example, if the person who talked with the person in charge on the phone is a principal, “principal” is stored in the call recipient column. If the person who talked with the person in charge on the phone is a customer's spouse, “spouse” is stored in the call recipient column. If the person who talked with the person in charge on the phone is another person, any information designated by the person in charge is stored in the call recipient column. If the person in charge could not contact the call recipient due to the absence, “none” is stored in the call recipient column. Meanwhile, “none” includes a case where the customer does not answer calls made to his or her personal mobile phone. The history content column includes information indicating the content of negotiations. For example, in a case where the customer responds to the telephone communication with the person in charge and a payment appointment is made between the person in charge and the customer, “payment appointment” is stored in the history content column. In addition, in a case where an ATM notification which is described later is performed, information of “ATM notification” is stored in the history content column. The history content column may include information indicating a date of a payment appointment. The information indicating a date of a payment appointment may be stored separately from the history content column illustrated in FIG. 5. In a case where there is a notification performed by using an ATM device 31, the template No. column stores the template No. used for generating a notification message. The negotiation memo column stores memos of the content of negotiations conducted between the person in charge and the call recipient. The person in charge column stores an ID of the person in charge when the negotiation by the person in charge is established.

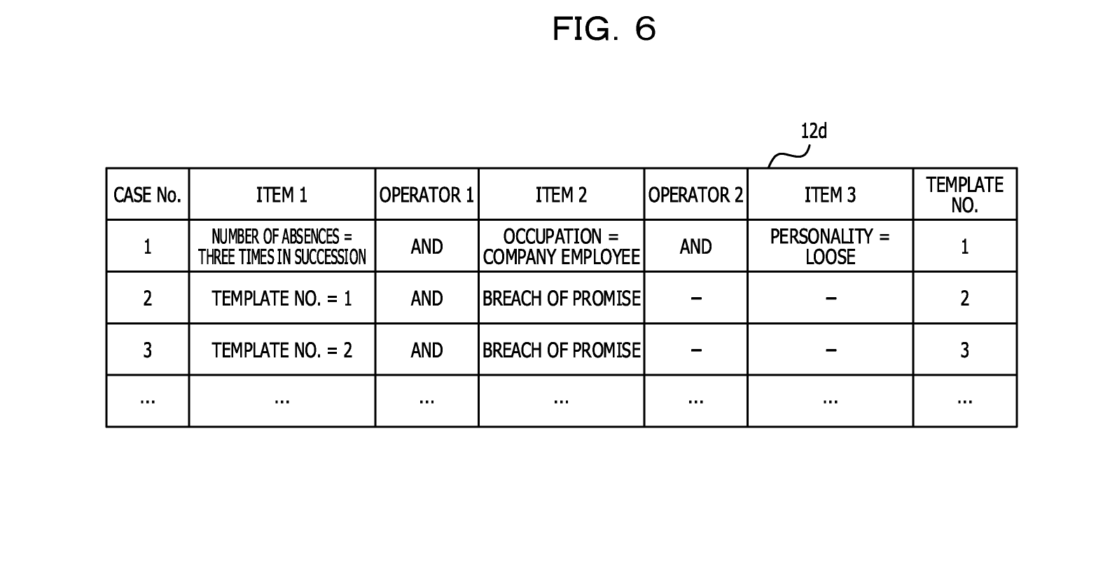

FIG. 6 illustrates an example of the record layout of the ATM notification determination DB 12d. The ATM notification is to notify the customer who is a debtor about payments by displaying a message for notifying about payments on the ATM device 31. The ATM notification determination DB 12d includes a case No. column, an item 1 column, an operator 1 column, an item 2 column, an operator 2 column, an item 3 column, and a template No. column. The case No. column stores the number for univocally specifying the case of performing the ATM notification. The item 1 column, the item 2 column, and the item 3 column respectively stores conditions for performing the ATM notification. The operator 1 column and the operator 2 column respectively store a logical operator. The operator which is stored in the operator 1 column and the operator 2 column is “AND” indicating a product or “OR” indicating a logical sum. The operator stored in the operator 1 column is used when performing a logic operation, on the authenticity of conditions set in the item 1 column and the authenticity of conditions set in the item 2 column. The operator stored in the operator 2 column is used when performing a logic operation, on the authenticity of conditions set in the item 1 column, the authenticity of conditions set in the item 2 column and the authenticity of conditions set in the item 3 column.

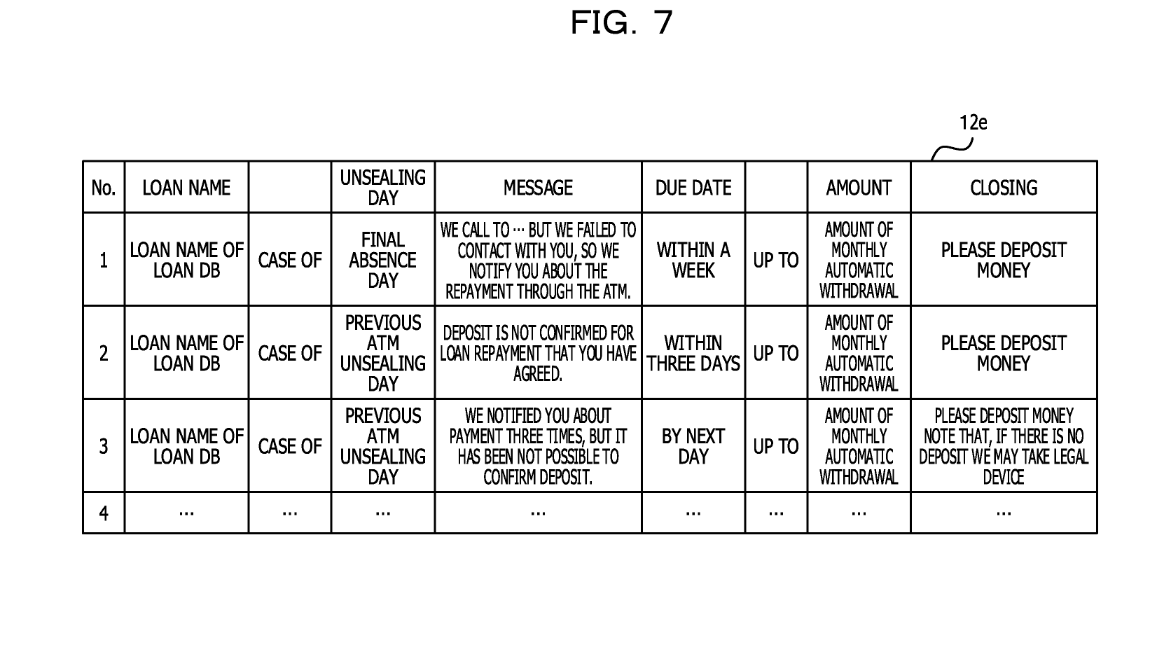

FIG. 7 illustrates an example of the record layout of the template DB 12e.The template DB 12e includes a No. column, a loan name column, an unsealing day column, a message column, a due date column, an amount column, and a close column. The No. column stores an ID univocally indicating the template. The loan name column stores reference information (pointer information) of the loan name included in the generated message. The unsealing day column stores the reference information of the date included in the generated message. The message column stores auto text included in the generated message. The due date column stores the reference information of the next due date included in the generated message. The amount column stores the reference information of the next amount of money to be paid included in the generated message. The close column stores the auto text which becomes a closing part in the generated message. Meanwhile, columns between the loan name column and the unsealing day column, and between the due date column and the amount column stores phrases which are to be compensated when generating the message.

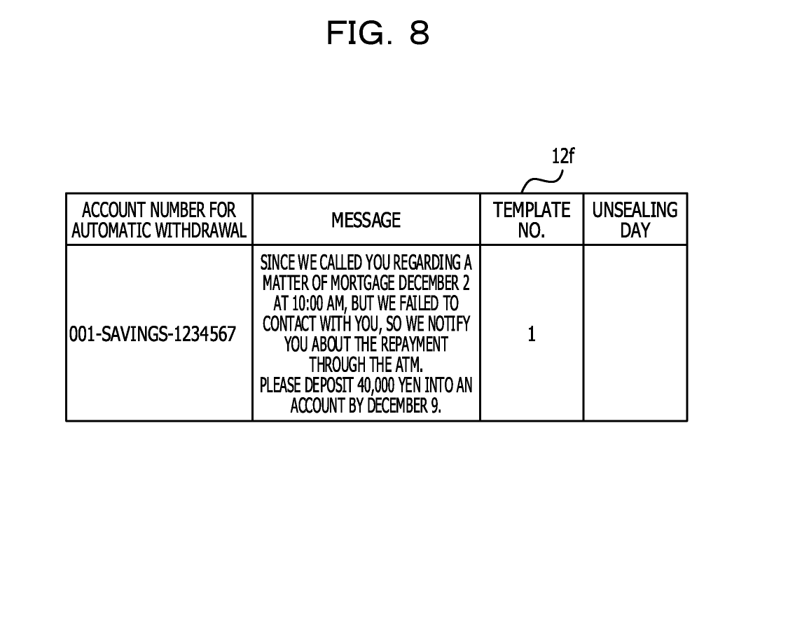

FIG. 8 illustrates an example of the record layout of the message DB 12f. The message DB 12f includes an account number for automatic withdrawal column, a message column, a template No. column, and an unsealing day column. The account number for automatic withdrawal column stores the account number of the customer who is an addressee of the message. The message column stores the message for the customer. The template No. column stores the number of templates used in generating the message. The unsealing day column stores the date when the customer read the message and then pressed a confirmation button. It is possible to determine whether or not the customer confirms the message depending on whether or not the date is stored in the unsealing day column. In a case where, as described below, the date (the confirmation date) when the customer pressed the confirmation button is stored in a message DB 22a, the date when the customer pressed the confirmation button may be stored in the unsealing day column in the same manner.

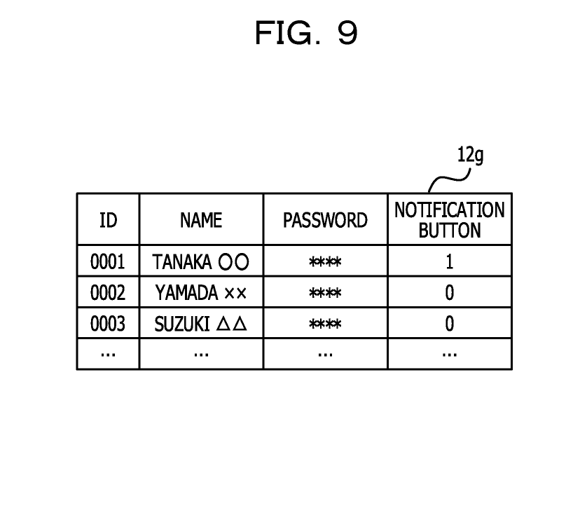

FIG. 9 illustrates an example of the record layout of the operator DB 12g. The operator DB 12g includes an ID column, a name column, a password column, and notifying button column. The ID column stores an ID univocally specifying an operator. The name column stores the operator's name. The password column stores a password to be input when the operator logs into an operator terminal 13. The notifying button column stores whether or not an instruction of the ATM notification is permitted to the operator. In a case where “1” is stored in the notifying button column, the operator corresponding to the record has the authority to instruct the payment notification system to perform the ATM notification with respect to the customer under the management of the operator. In a case where “0” is stored in the notifying button column, the operator corresponding to the record is not able to have the authority to instruct the payment notification system to perform the ATM notification with respect to the customer under the management of the operator. The reason for the operator to instruct the payment notification system to perform the ATM notification is so as to perform the ATM notification even when there is a case which is not applicable to a case defined by the ATM notification determination DB 12d. The skillful operator can expect that it takes such a long period of time to complete the repayment by the customer by checking the customer's attitude on the phone and self-experience. In this case, in an initial reminder stage, it is possible to efficiently advance the payment notification work by allowing the operator to use the ATM notification.

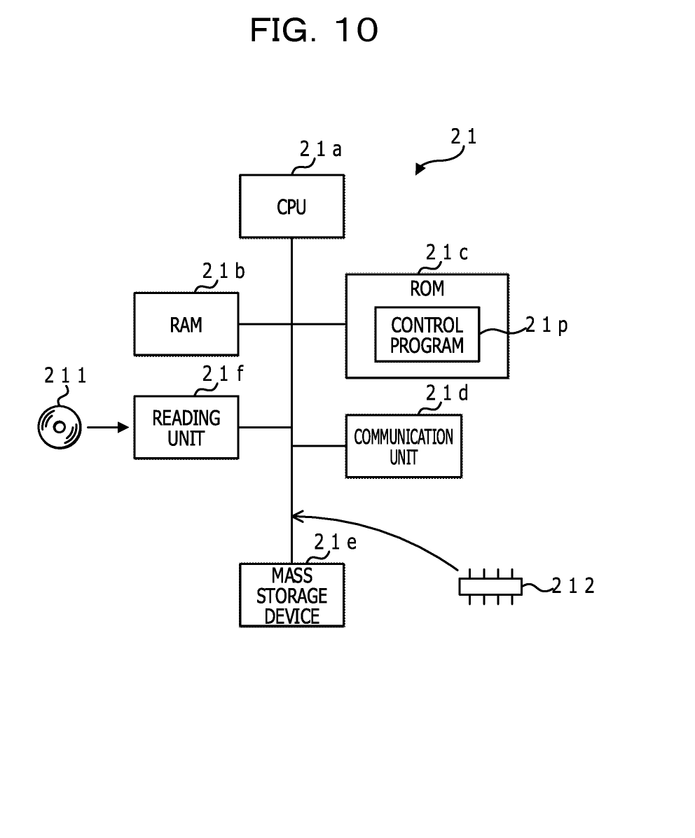

FIG. 10 illustrates an example of a configuration of hardware of the accounting server 21 included in the accounting system 2. The accounting server 21 includes a CPU 21a, a RAM 21b, a ROM 21c, a communication unit 21d, a mass storage device 21e, and a reading unit 21f. These components are coupled to each other via a bus. The CPU 21a controls each hardware unit according to a control program 21p stored in the ROM 21c. The RAM 21b is, for example, the SRAM, the DRAM, or the flash memory. The RAM 21b temporarily stores data generated when performing a program by the CPU 21a. The communication unit 21d has a function of communicating with the call center server 11 via the network N. The mass storage device 21e is, for example, the hard disk or the SSD. The mass storage device 21e temporarily stores data to be stored in the database 22. In addition, the mass storage device 21e may be set to store the control program 21p.

The reading unit 21f reads a portable storage medium 211. The CD-ROM and the DVD-ROM are examples of the portable storage medium 211. The CPU 21a may read the control program 21p from the portable storage medium 211 via the reading unit 21f and store the control program 21p in the mass storage device 21e. In addition, the CPU 21a may download the control program 21p from another computer via the network N and store the control program 21p in the mass storage device 21e. The CPU 21a may read the control program 21p from a semiconductor memory 212.

Next, data stored in the database 22 of the accounting system 2 will be described. The database 22 stores a message DB 22a, and a deposit and withdrawal history DB 22b. The message DB 22a is the same as the message DB 12f of the call center system 1, and thus the description thereof will not be repeated.

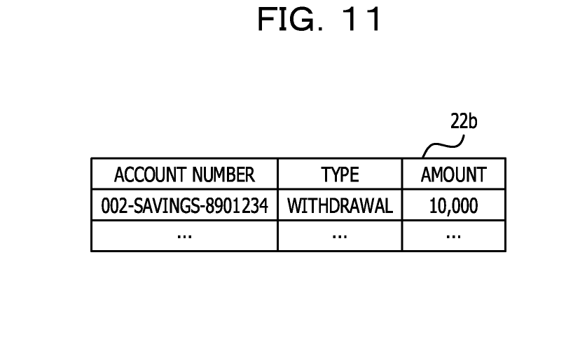

FIG. 11 illustrates an example of the record layout of the deposit and withdrawal history DB 22b. The deposit and withdrawal history DB 22b includes an account number column, a type column, and an amount column. The account number column stores the account number of the account used in the transaction. The type column stores the type of the performed transaction, for example, the deposit and the withdrawal. The amount column stores the amount of money that has been transacted.

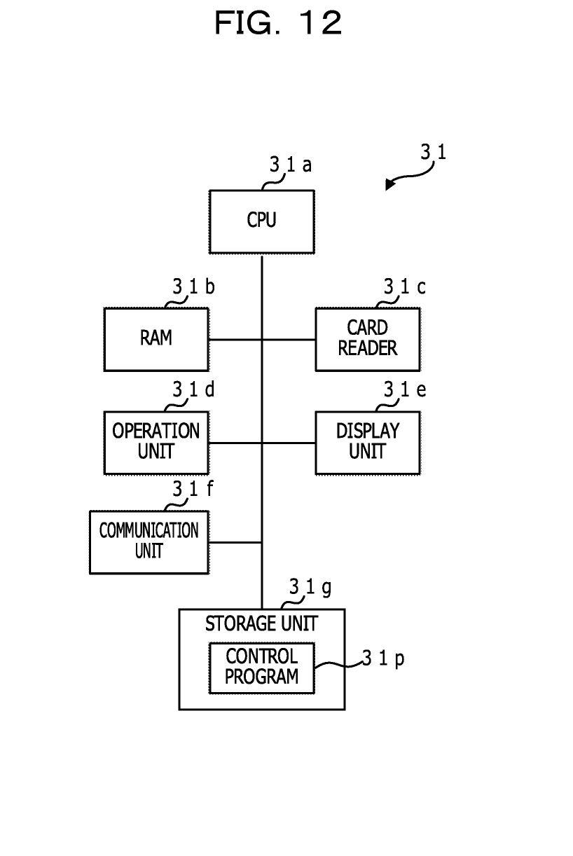

FIG. 12 illustrates an example of a configuration of hardware of the ATM device 31. The ATM device 31 is an example of the terminal device 3. The ATM device 31 includes a CPU 31a, a RAM 31b, a card reader 31c, an operating unit 31d, a display unit 31e, a communication unit 31f, and a storage unit 31g. These components are coupled to each other via a bus. The CPU 31a controls each hardware unit according to a control program 31p stored in the storage unit 31g. The RAM 31b is, for example, the SRAM, the DRAM, or the flash memory. The RAM 31b temporarily stores data generated when performing a program by the CPU 31a. The card reader 31c reads a cash card of the customer and acquires a customer number from the cash card. The operating unit 31d is a touch panel which is, for example, integrated with the display unit. The operating unit 31d receives an operation input from the customer. The display unit 31e displays a message for the customer. The communication unit 31f is provided with a function of communicating with the accounting server 21 via the network N.

Next, an information process performed in the call center server 11 will be described. A list of persons in arrears (not illustrated) to be notified is assumed to be made in advance as a premise of the information process as indicated below. The list of persons in arrears is an example of the customer information storage unit. The list of persons in arrears includes the customer number of a person in arrears and a loan account number in arrears. The call center server 11 creates the list of persons in arrears for every predetermined period of time. For example, the creation of the list of persons in arrears is performed once a day as daily batch processing.

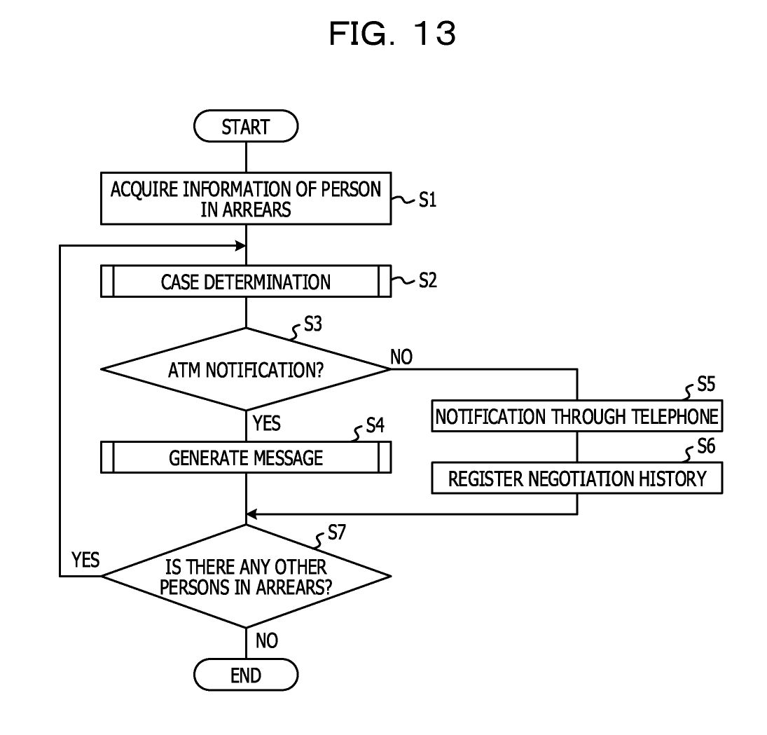

FIG. 13 is a flowchart illustrating an example of a procedure of a notification process. The CPU 11a of the call center server 11 extracts the customer number and the loan account number of the person in arrears from the list of persons in arrears (step S1). The CPU 11a determines a case of the person in arrears (step S2).

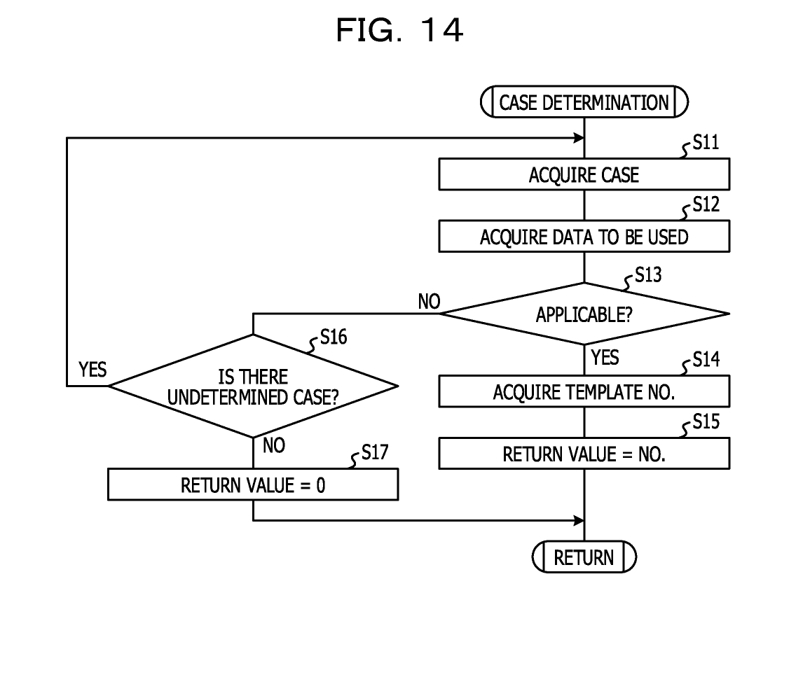

FIG. 14 is a flowchart illustrating an example of a procedure of a case determination process. The CPU 11a acquires an unprocessed record, that is, data related to an unconfirmed case from the ATM notification determination DB 12d (step S11). The CPU 11a acquires data related to the person in arrears to be processed (step S12). The data is used to determine whether or not the case of the person in arrears is applicable to the acquired case. The CPU 11a determines whether or not the person in arrears to be processed is applicable to the case based on the data related to the acquired unconfirmed case and the data related to the person in arrears (step S13). If the person in arrears to be processed is applicable to the case (YES in step S13), the CPU 11a acquires the template No. corresponding to the applicable case (step S14). The CPU 11a sets the acquired template No. to a return value (step S15). If the person in arrears to be processed is not applicable to the case (NO in step S13), the CPU 11a determines whether or not there is an unconfirmed case (step S16). If there is the unconfirmed case (YES in step S16), the process of the CPU 11a returns to step S11. If there is no unconfirmed case (NO in step S16), the CPU 11a sets the return value to “0” (step S17). After performing step S15 or step S17, the process of the CPU 11a is completed and returns to a caller (step S2 in FIG. 13).

The process returns to FIG. 13, and the CPU 11a determines whether or not the ATM notification is to be performed according to the result of the case determination (step S3). When the ATM notification is performed (YES in step S3), the CPU 11a generates a message (step S4). When the return value is other than “0” through the case determination process illustrated in FIG. 14, the CPU 11a determines that the ATM notification is performed.

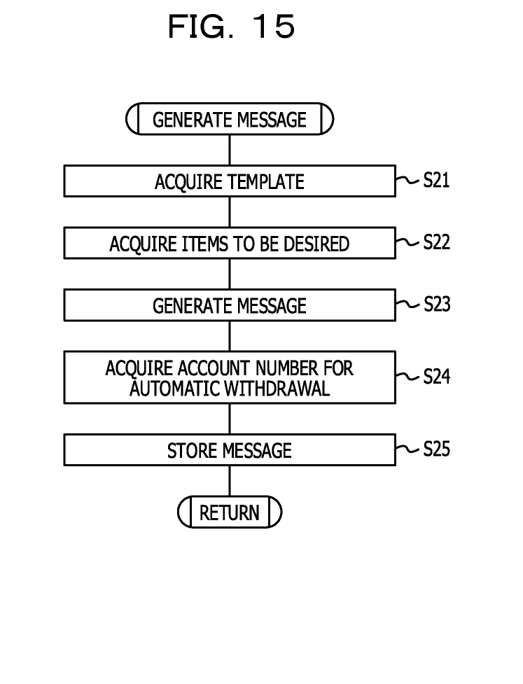

FIG. 15 is a flowchart illustrating an example of a procedure of a message generating process. The CPU 11a acquires data of the template corresponding to the template No. which is the return value of the case determination process from the template DB 12e (step S21). The CPU 11a acquires the items for generating the message based on the reference information designated in the template (step S22). The CPU 11a applies the acquired item to the template and generates the message (step S23). The CPU 11a acquires the account number for automatic withdrawal from the customer number and the loan account number of the person in arrears to be processed (step S24). The CPU 11a stores the generated message in the message DB 12f in association with the acquired account number for automatic withdrawal and the template No. used in generating the message (step S25). The CPU 11a completes the process and returns the process to the caller (step S4 in FIG. 13).

In a case where the ATM notification is not performed (NO in step S3), the CPU 11a prompts the operator to notify the customer about the repayment on the phone as in the related art (step S5). When the return value obtained through the case determination process illustrated in FIG. 14 is “0”, the CPU 11a determines that the ATM notification is not performed. The operator notifies the customer about the repayment on the phone and then inputs the result by using the operator terminal 13. The CPU 11a registers the input history with the negotiation history DB 12c (step S6). The CPU 11a determines whether or not there are additional persons in arrears to be processed after completing step S4 or step S6 (step S7). If there are additional persons in arrears to be processed (YES in step S7), the process of the CPU 11a returns to step S2. If there is no additional person in arrears to be processed any more (NO in step S7), the CPU 11a completes the process.

Next, a specific example of generating a message will be described. Hereinafter, it is assumed that arrears occur in the loan account number 1001 of the customer number 100.

In step S1 of FIG. 13, the CPU 11a acquires the customer number 100 and the loan account number 1001. Next, the CPU 11a performs the case determination process (step S2). In step S11 of FIG. 14, the CPU 11a acquires the case having the case No. “1”. As illustrated in FIG. 6, in the case No. 1, the item 1 denotes “the number of absences=three times in succession”, the item 2 denotes “occupation=a company employee”, and the item 3 denotes “personality=loose”. In addition, the operator 1 denotes “AND” and the operator 2 denotes “AND” as well. That is, in this case, when the number of absences is three times in succession, the occupation is the company employee, and the personality is loose, the ATM notification is defined to be performed.

Next, the CPU 11a acquires the aforementioned data of the customer number 100 (step S12). The number of absences is calculated based on the negotiation history DB 12c. In the negotiation history DB 12c illustrated in FIG. 5, when the record of which the customer number is 100 and the loan account number is 1001 is acquired and the acquired record is sorted in descending order of the history number, it is possible to recognize, from the content of the call recipient column, that there has been an absence three times in succession recently. Accordingly, the determination of the item 1 is “truth”. The data relating to the occupation can be acquired from the debtor DB 12a. As illustrated in FIG. 3, the occupation of the customer having the customer number 100 is a “company employee”. Accordingly, the determination of the item 2 is also “truth”. In addition, the data relating to the personality can be acquired from the debtor DB 12a as well. As illustrated in FIG. 3, the personality of the customer having the customer number 100 is “loose”. Accordingly, the determination of the item 3 is also “truth”. Since the operator 1 and the operator 2 are “AND”, in step S13 of the flowchart illustrated in FIG. 14, the CPU 11a determines that the customer having the customer number 100 is applicable to the acquired case based on the result of the logical product of the truth values of the item 1 to the item 3.

The CPU 11a acquires the template No. corresponding to the applicable case (step S14). Here, as illustrated in FIG. 6, the template No. is “1”. The CPU 11a sets “1” to the return value and then completes the process.

The CPU 11a determines YES in step S3 in FIG. 13 and generates a message. In step S21 of FIG. 15, the CPU 11a acquires the template from the template DB 12e. Next, the CPU 11a acquires the data for generating the message by using the acquired template. As illustrated in FIG. 7, in the template having template No. “1”, the loan name is indicated with the loan name in the loan DB 12b. Here, as illustrated in FIG. 4, the loan indicated with the customer number of “100” and the loan account number of “1001” has the name of “a mortgage”.

In addition, as illustrated in FIG. 7, in the template having template No. “1”, the unsealing day means “the final day of absence”. The final day of absence can be calculated based on the negotiation history DB 12c. As illustrated in FIG. 5, in the negotiation history DB 12c, the final day of absence of the customer having the customer number of “100” and the loan account number of “1001” is “December 2, 10:00 AM” (refer to history number 4).

In addition, as illustrated in FIG. 7, since a due date of the template having the template No. “1” is “within a week”, the due date is December 9 which means after a week from the unsealing day. Further, as illustrated in FIG. 7, the amount in the template having the template No. “1” is “the amount of monthly automatic withdrawal”. The amount of monthly automatic withdrawal can be acquired based on the loan DB 12b. As illustrated in FIG. 4, the amount of monthly automatic withdrawal of the loan indicated with the customer number of “100” and the loan account number of “1001” is 40,000 yen. According to the above description, a plurality of pieces of data for generating the message are prepared. The CPU 11a generates the message based on these pieces of data and the template (step S23). The generated message is as follows; “since we called you regarding a matter of mortgage on December 2 at 10:00 AM, but we failed to contact you, we will notify you about the repayment through the ATM. Please deposit 40,000 yen into an account by December 9”.

Further, the CPU 11a acquires the account number for automatic withdrawal of the loan having the customer number of “100” and the loan account number of “1001” based on the loan DB 12b (step S24). As illustrated in FIG. 4, the account number for automatic withdrawal of the loan having the customer number of “100” and the loan account number of “1001” is “001-savings-1234567”. Then, the template No. used in generating the message is “1”. The CPU 11a stores the message, the account number for automatic withdrawal, and the template No. in the message DB 12f (step S25). FIG. 8 illustrates the storing result.

The above is a series of processes of generating the message with respect to the person in arrears with which it is difficult to contact. Next, the process in which the message is displayed with respect to the person in arrears and then the confirmation button is pressed will be described. As described later, the message DB 12f of the call center system 1 and the message DB 22a of the accounting system 2 are regularly subjected to a synchronous process. Through this synchronous process, the message generated in the aforementioned process is stored in the message DB 22a.

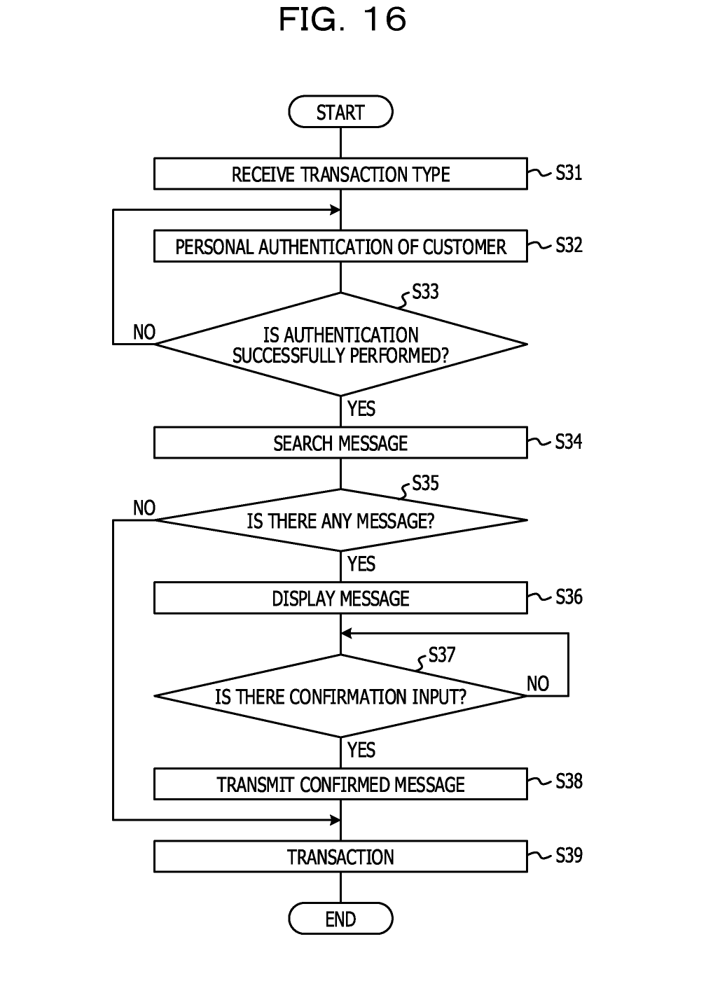

FIG. 16 is a flowchart illustrating an example of the procedure of a message display process. Meanwhile, as described above, the terminal device in this process is the ATM device 31. First, the CPU 31a of the ATM device 31 receives the transaction type which is performed by the customer via the operating unit 31d (step S31). The transaction type is, for example, the deposit and the withdrawal of money; a type of the transaction performed between the customer and a bank by using the ATM device 31.

Next, a personal authentication of the customer is performed (step S32). The personal authentication is performed as follows, for example. The CPU 31a displays a sentence for notifying the customer that a cash card is to be read by the card reader 31c on the display unit 31e. The CPU 31a reads the customer number from the cash card via the card reader 31c. The CPU 31a displays a sentence for notifying the customer of an input of a password on the display unit 31e and receives the password input by the customer via the operating unit 31d. The CPU 31a makes inquiries about whether or not the combination of the customer number and the received password are correct with the accounting server 21. The CPU 21a of the accounting server 21 determines whether or not the inquired combination of the customer number and the password is correct by comparing the combination of the customer number and the password which are stored in the debtor DB (not illustrated) with the inquired combination of the customer number and the password. The CPU 21a transmits the determination result back to the ATM device 31.

The CPU 31a of the ATM device 31 determines the determination result of the personal authentication (step S33). When the personal authentication is successful (YES in step S33), the CPU 31a performs the searching of the message (step S34). When the personal authentication is failed (NO in step S33), the process of the CPU 31a returns to step S32 and the personal authentication is performed again.

The searching of the message is performed via the accounting server 21. The CPU 31a transmits the customer number to the accounting server 21 and makes inquiries about whether or not the message is associated with the customer number with the accounting server 21. The CPU 21a of the accounting server 21 searches the message DB 22a and verifies whether or not the message is associated with the received customer number. When there is no message, the CPU 21a transmits the fact there is no message to the ATM device 31. On the other hand, when there is a message, the CPU 21a transmits the fact that there is a message and the message acquired by searching to the ATM device 31.

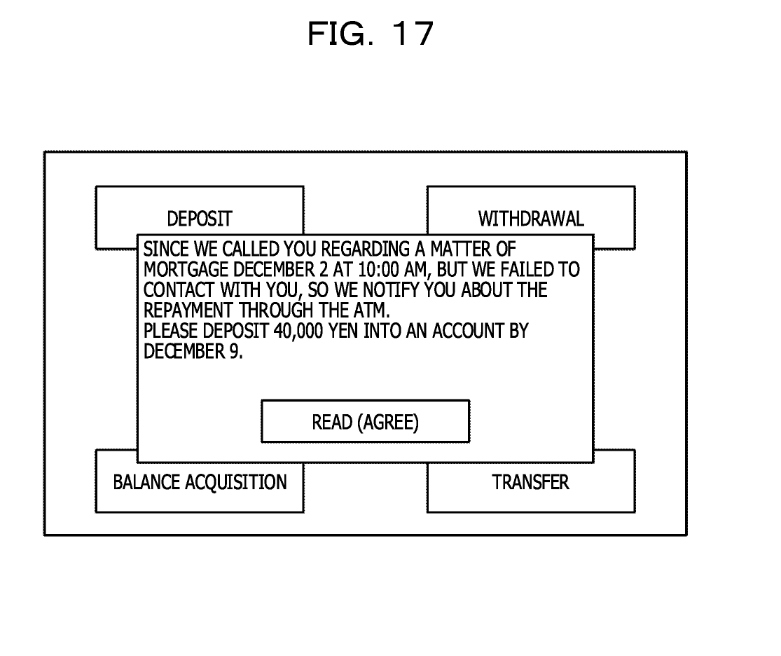

The CPU 31a of the ATM device 31 determines whether or not there is a message according to a reply from the accounting server 21 (step S35). If it is determined that there is a message (YES in step S35), the CPU 31a displays the message received from the accounting server 21 to the display unit 31e and the confirmation button for the input of the fact that the message is confirmed on the display unit 31e (step S36). FIG. 17 illustrates an example of the display unit 31e on which the message is displayed in the ATM device 31. In FIG. 17, the caption “I have read (agree)” is displayed in the confirmation button.

The CPU 31a determines whether or not the confirmation input is performed by the confirmation button (step S37). When there is no confirmation input (NO in step S37), the CPU 31a performs the process in step S37 again. When there is the confirmation input (YES in step S37), the CPU 31a transmits the fact that there is the confirmation input to the accounting server 21 (step S38). The CPU 21a of the accounting server 21 stores the date and time of reception of the confirmation input in the confirmation date and time column of the message DB 22a. The confirmation date and time column of this message DB 22a corresponds to the aforementioned unsealing day column of the message DB 12f. After step S38, or when it is determined that there is no message (NO in step S35), the CPU 31a performs the transaction selected by the customer in an operation of the display unit 31e (step S39) and then completes the process. Regarding the process relating to the transaction, a common technique may be employed.

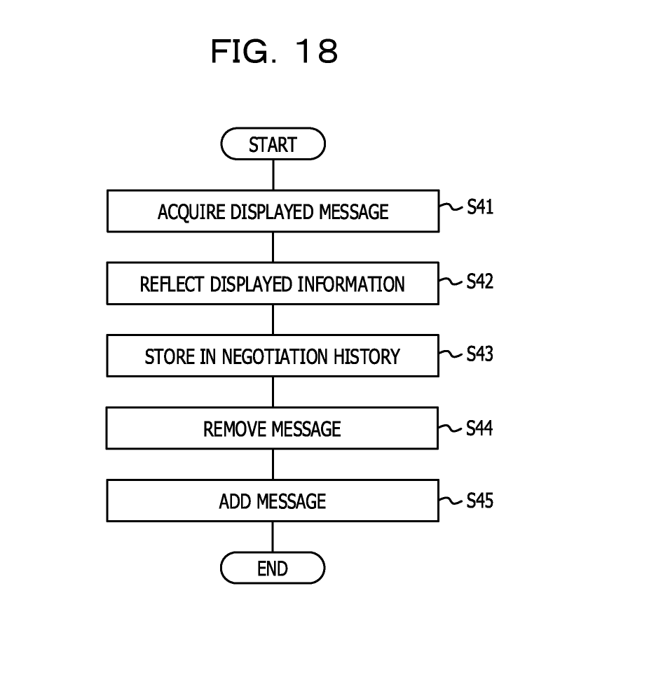

Next, the synchronous process of the message DB 12f of the call center system 1 and the message DB 22a of the accounting system 2 will be described. FIG. 18 is a flowchart illustrating an example of a procedure of the synchronous process. The call center server 11 and the accounting server 21 cooperate with each other so as to perform a synchronous process.

The CPU 11a of the call center server 11 makes inquires with the accounting server 21 so as to acquire the displayed message among the messages stored in the message DB 22a (step S41). That is, the CPU 11a acquires the message in which the confirmation date and time is recorded from the message DB 22a. Based on the confirmation date and time of the acquired message, the CPU 11a stores the confirmation date and time corresponding to the confirmation date and time of the acquired message in the record of the message DB 12f and reflects the displayed information thereto (step S42).

The CPU 11a stores the fact that the message is confirmed in the negotiation history DB 12c based on the confirmation date and time of the acquired message (step S43). Specifically, the CPU 11a stores the confirmation date and time of the acquired message in the negotiation date and time column of the negotiation history DB 12c. In addition, the CPU 11a stores “negotiation” in the distribution column and in the call recipient column “principal”. The “ATM notification” is stored in the history content column and “system” is stored in the person in charge column. The CPU 11a stores the message in the negotiation memo column.

The CPU 11a performs removing of the displayed message (step S44). The CPU 11a transmits information which illustrates removing the message acquired in step S41 to the accounting server 21. The CPU 21a of the accounting server 21 removes the displayed message based on the information received from the call center server 11. Additionally, the CPU 11a of the call center server 11 may remove the displayed message from the message DB 12f.

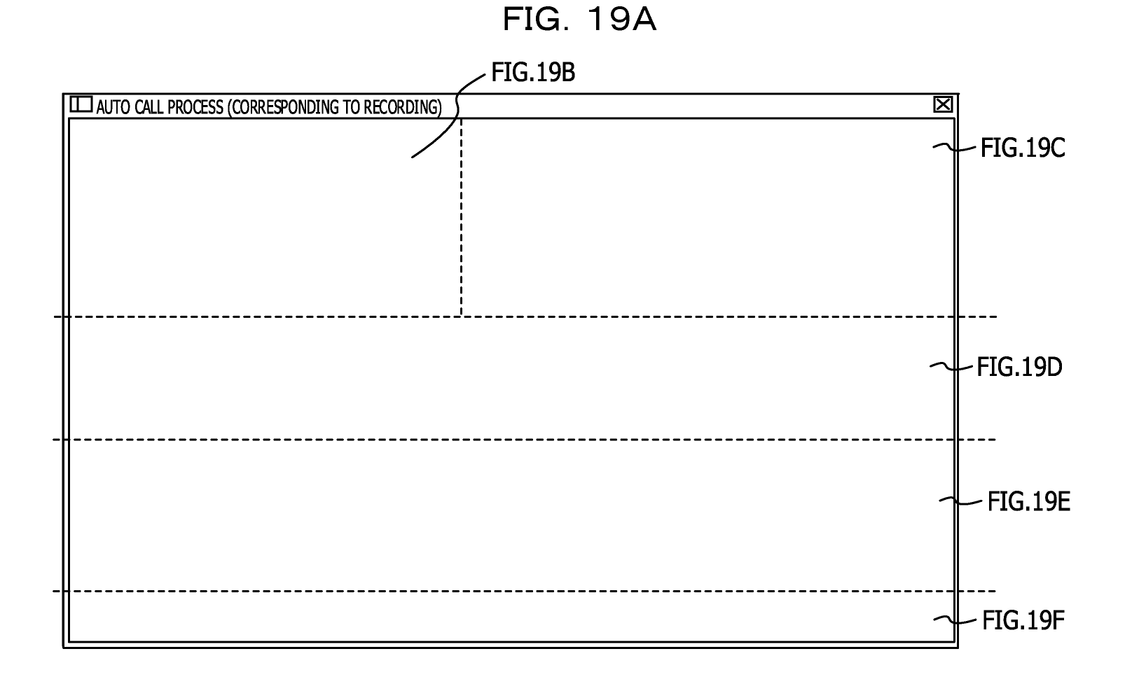

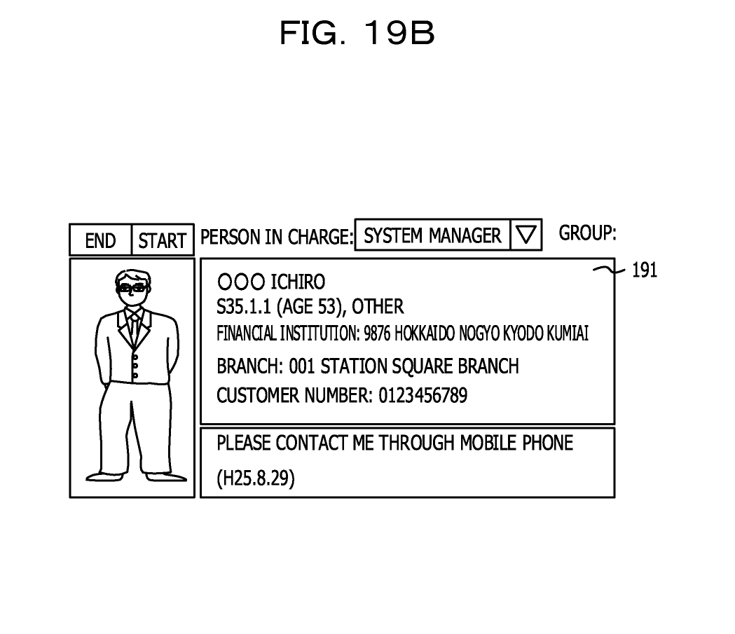

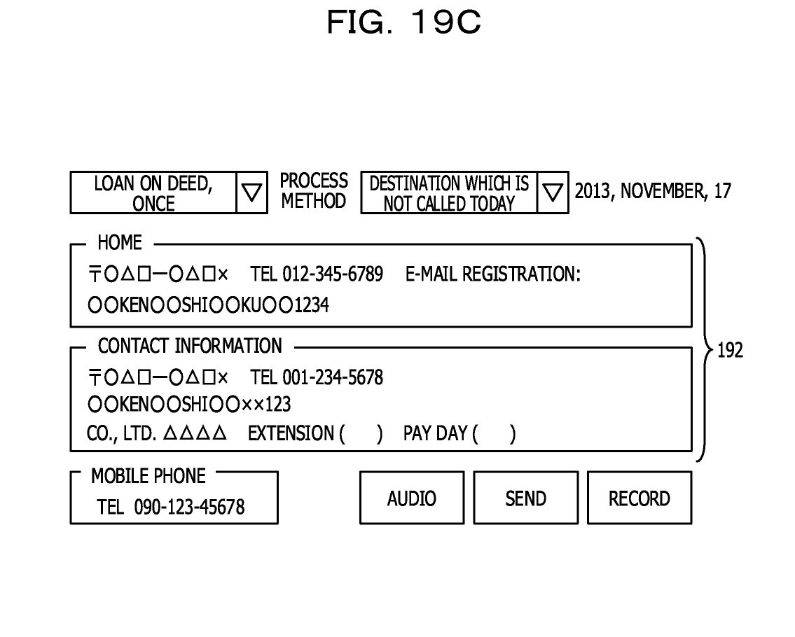

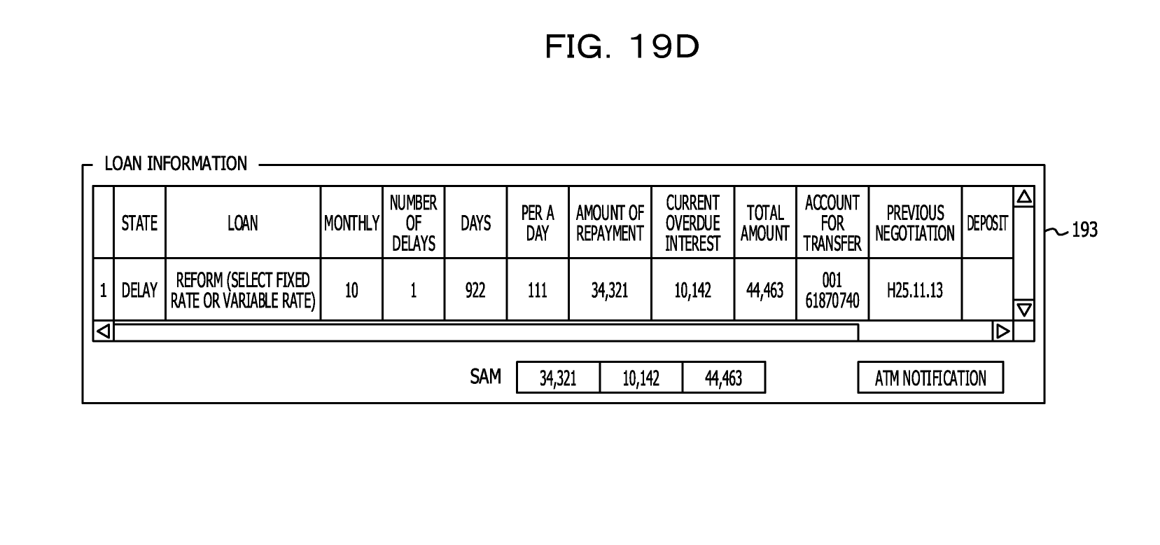

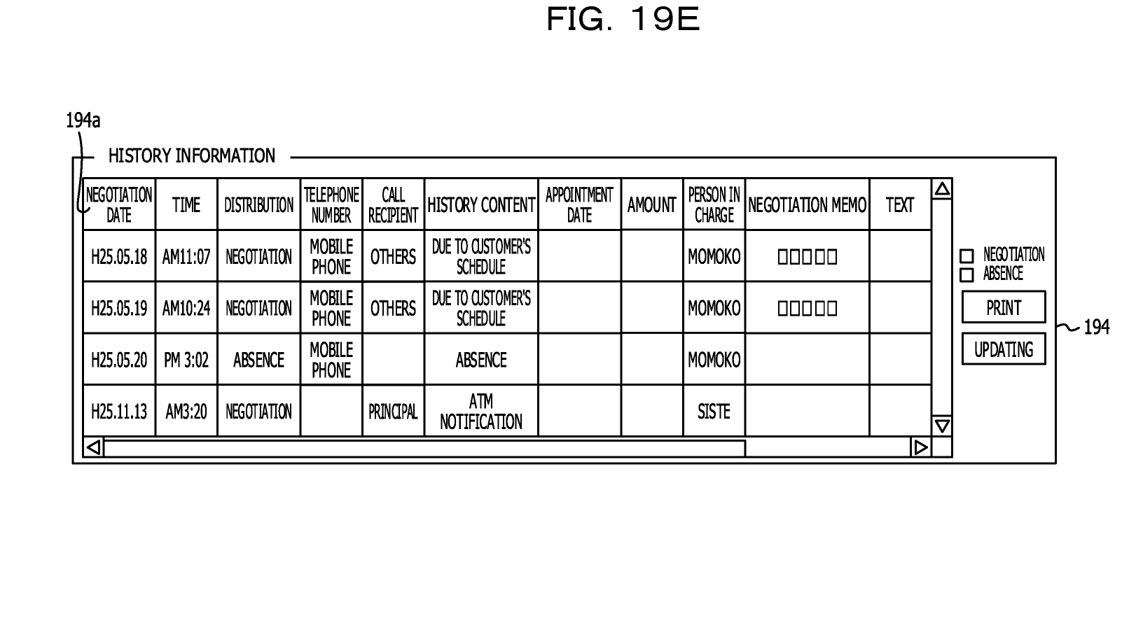

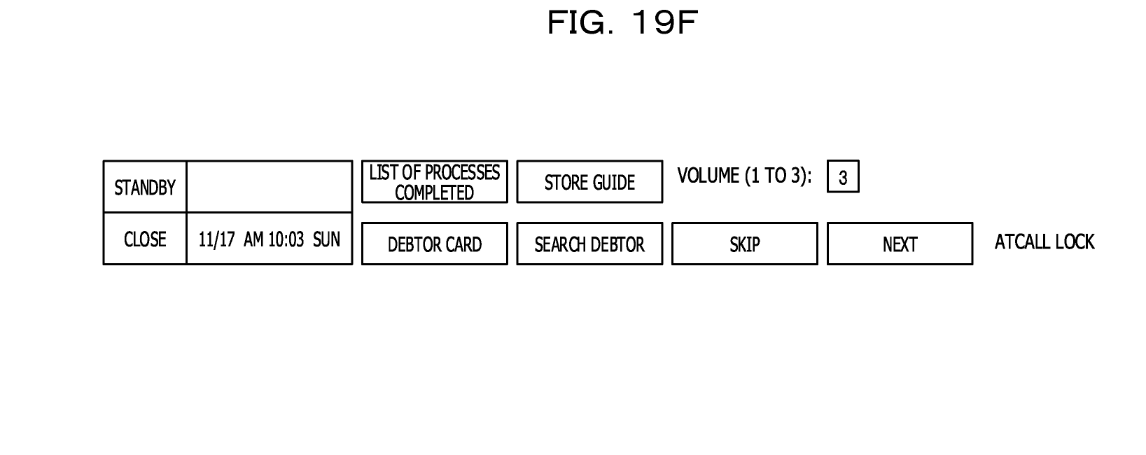

The CPU 11a performs an additional process of the message (step S45). The additional process of the message will be described below in detail. The CPU 11a makes inquiries with the accounting server 21 so as to acquire the displayed message among the messages stored in the message DB 22a. The CPU 11a compares a non-displayed message stored in the message DB 12f and an acquired non-displayed message. The CPU 11a specifies the message which is stored in the message DB 12f but not stored in the message DB 22a based on the comparison. The CPU 11a transmits the specified message to the accounting server 21. The CPU 21a of the accounting server 21 adds the non-displayed message received from the call center server 11 to the message DB 22a. Thereafter, the CPU 21a completes the process. FIGS. 19A, 19B, 19C, 19D, 19E and 19F illustrate an example of a screen displayed on an operator terminal 44 in the call center. The screen illustrated in FIG. 19A includes a customer information display column 191 in FIG. 19B, a customer contact number information display column 192 in FIG. 19C, a loan information display column 193 in FIG. 19D, a history information display column 194 in FIG. 19E, and other display area including various buttons and status display columns in FIG. 19F. The history of the message display by the ATM device 31 is a record 194a of the history information display column 194. The CPU 11a of the call center server 11 may generate, for example, image data as illustrated in FIG. 19 for the target customer based on a request of the operator terminal 44. When generating the image data, the CPU 11a acquires the negotiation date and time corresponding to the customer number of the customer to be processed among the negotiation dates and times registered with the negotiation date and time column of the negotiation history DB 12c so as to set to the negotiation date and time of the history information display column 194. The CPU 11a acquires the data corresponding to the customer number of the customer to be processed among the pieces of data registered in each of the distribution column, the call destination column, the call recipient column, the history content column, the person in charge column, and the negotiation memo column in the negotiation history DB 12c so as to respectively set the distribution, the call destination, the call recipient, the history content, the person in charge, and the negotiation memo in the history information display column 194. In addition, if the appointment date and the appointment amount for repayment are included in the negotiation memo column of the negotiation history DB 12c, the CPU 11a sets each of the appointment date and the appointment amount for repayment to the appointment date and the amount in the history information display column 194. The CPU 11a of the call center server 11 transmits the generated image data to the operator terminal 44 of a request source.

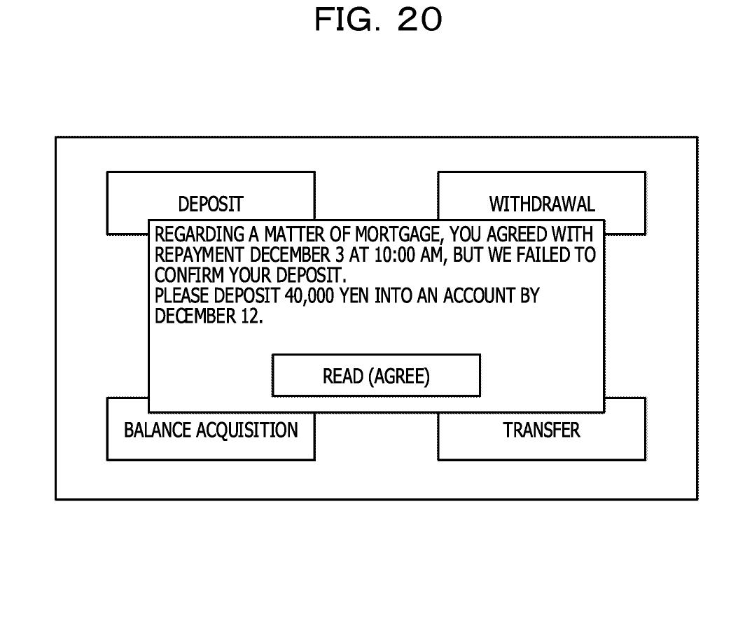

Next, the changing of the generated message when the ATM notification is repeatedly performed will be described. If the deposit is not confirmed by the first time of ATM notification, it becomes a breach of promise. For example, if the deposit from the customer has not been made even after the due date of the deposit, which is included in the negotiation history, according to the ATM notification, it may be determined to be the breach of promise. The customer in this situation is applicable to the case No. 2 in FIG. 6. In the case No. 2, the item 1 denotes “template No.=1” and the item 2 denotes “breach of promise”. In the case No. 2, the item 3 is not defined. In the case No. 2, the operator 1 denotes “AND”. Here, the item 1 is “truth” if the template No. which is used when the previous message is generated is “1”. The item 2 is “truth” when the “breach of promise” is generated. That is, after checking the message generated in the template No. 1 in the ATM device 31, the customer who responds to the payment until a designated date but does not meet the due date and thus becomes “breach of promise” after all is corresponded to the case No. 2. Since this type of customer is applicable to the case No. 2, the message generated by the template No. 2 is displayed on the ATM device 31. FIG. 20 illustrates an example of the display unit on which the message is displayed in the ATM device 31. FIG. 20 illustrates an example in which the message generated by the template No. 2 is displayed.

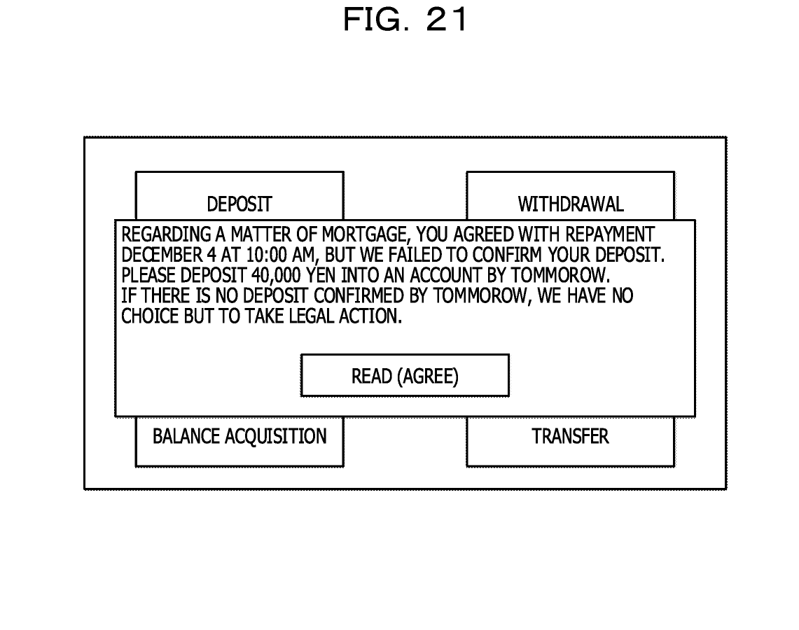

A case where the customer became “breach of promise” even though he or she agreed with the message as illustrated in FIG. 20 is applicable to the case No. 3 in FIG. 6, and the message generated by the template No. 3 is displayed with respect to the customer. FIG. 21 illustrates an example of a display unit on which a message is displayed in the ATM device 31. FIG. 21 illustrates an example in which the message generated by the template No. 3 is displayed.

As described above, in the first embodiment, if there is a message for the person in arrears, the message is displayed on the display unit before the customer who is the person in arrears performs the transaction at the ATM device 31. Then, in the first embodiment, the normal transaction is not available as long as the customer does not input the fact that the content of the message is confirmed. With this configuration, the delivery of the message to the customer is reliably performed. In addition, since the date and time when the confirmation is input by the customer is stored, it is possible to manage the date and time as the history information similar to the case where the telephone communication to the customer is performed from the call center.

Further, since the message with more intense content for notification of the payment is generated as the output number of messages increases, it is possible to strongly prompt the customer to deposit money.

As described above, in the payment notification work, when the person in arrears does not respond to the payment regardless of the third notification on the phone, a request for repayment is realized by legal device against the person in arrears. In order to take the legal device, a recovery obligation wanted by the Financial Services Agency has to be satisfied. As evidence for the recovery obligation, desired is, for example, evidence that the operator surely contacts the customer himself/herself and the request for withdrawing money is directly performed to the customer himself/herself. However, with only the record in which the operator from the call center made calls to try to contact the customer but failed due to the absence, it is unlikely to be recognized that the recovery obligation is fulfilled. From such a circumstance, recording a message display and confirmation messages can be information indicating the evidence fulfilling the above recovery obligation.

Meanwhile, in the first embodiment, there is a description that the message with more intense content for notification of the payment is generated as the output number of messages increases, but there is no limit thereto. A template which has a different strength of the notification of the payment of message according to a degree of content change of the debtor DB 12a may be used. For example, the message with more intense content for notification of the payment may be generated with respect to the customer who frequently changes a contact number, an address, and an occupation.

In this case, first, a plurality of templates which have almost the same content but have different styles, tones, and words used are prepared in the template DB 12e. Then, by providing a case including any one of “change degree=high”, “change degree=middle”, and “change degree=low” as a determination item of the ATM notification determination DB 12d, the template having a different strength may be respectively assigned to each case.

Second Embodiment

In the first embodiment, as an example of a condition for performing the ATM notification, the condition in which the number of absences is three times in succession is indicated. This condition of the number of the absences may be varied by other conditions. For example, it may be changed according to the size of the loan balance. For a bank, since the larger the balance, the larger the damage when the recovery is not possible, it is preferable that the number of absences which is the determination condition for performing the ATM notification be set to be smaller as the balance is larger. In addition, it is preferable that the number of absences which is the determination condition for performing the ATM notification be set to be small with respect to the customer who frequently changes the contact number, the address, and the occupation. It is because, in consideration that the customer who frequently changes the contact number, the address, and the occupation tends to avoid social relationships, it is highly likely to fail to contact such a customer.

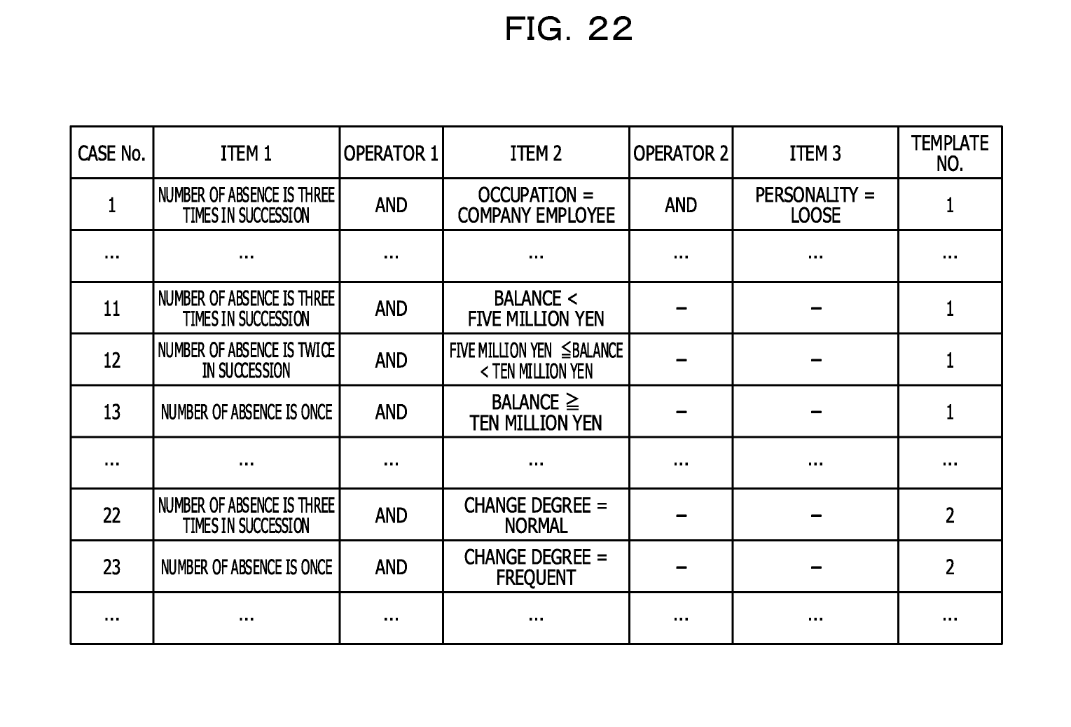

FIG. 22 illustrates an example of the record layout of the ATM notification determination DB 12d according to the second embodiment. The case Nos. 11 to 13 are examples of the cases where conditions relating to the determination of the number of absences in succession are differentiated according to the loan balance. The case Nos. 22 and 23 are examples of the cases where conditions relating to the determination of the number of absences in succession are differentiated according to the change degree of the contact number, the address, and the occupation. The different point between the first embodiment and the second embodiment is the content of the ATM notification determination DB 12d. Since the configuration of the hardware and the content of the information process is the same as those in the first embodiment, the description thereof will not be repeated.

The following effects are accomplished in the second embodiment. The conditions relating to determination of the number of absences in succession which serves as the determination standard of performing the ATM notification are defined based on different factors for each customer such as the loan balance or the change degree of the customer information, and thus it is possible to properly set a threshold value for each customer. Accordingly, it is possible to reduce the number of useless telephone communications from the call center to the customer.

Third Embodiment

In the second embodiment, the example of changing the number of absences in succession which serves as the determination standard of performing the ATM notification was illustrated, but a count method of counting the number of absences based on the negotiation history may be changed. In the following description, the different points from the first embodiment are mainly described and the same parts as in the first embodiment will not be repeated.

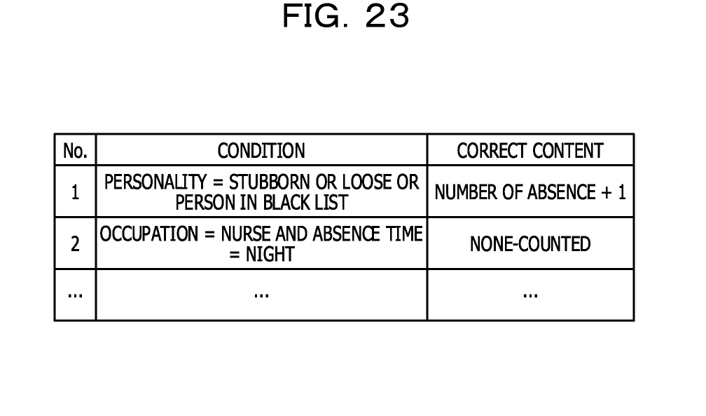

FIG. 23 illustrates an example of the record layout of the absence determination correction DB relating to the third embodiment. The absence determination correction DB is stored in the database 12 of the call center system 1. The absence determination correction DB includes a No. column, a condition column, and a correction content column. The No. column stores numbers of records in order. The condition column stores conditions of correcting the number of absences. The correction content column stores the correction content of the number of absences.

In a case where the personality of the customer to be processed is stubborn or loose, or the customer to be processed is a person on the blacklist, a correction No. 1 in FIG. 23 indicates to add 1 to the number of absences obtained based on the negotiation history and then to perform the ATM notification determination by using the ATM notification determination DB 12d. In a case where the customer's occupation is a nurse and the time zone of absence is night time (for example, from 20:00 to 08:00), a correction No. 2 indicates not to count the number as the absence even when the customer is absent. This is the correction content taking into consideration the nurses who often work the night shift.

The following effects are accomplished in the third embodiment. In the third embodiment, it is possible to correct the number of absences in succession which serves as the determination standard of performing the ATM notification. As such, for example, even if the customer is absent at the time zone in which the person working in the day time is highly likely to be contacted, or even in a case of the customer who mainly works at night due to the nature of their occupation, the number of absences in succession is not counted. Therefore, it is possible to properly count the number of the absences in succession.

Fourth Embodiment

In the first embodiment, the second embodiment, and the third embodiment, the call center server 11 determines whether or not to perform the ATM notification by using the ATM notification determination DB 12d, but, the ATM notification may be performed by the determination of the operator. For example, this is because a case where there is an announcement that the number is not available even though the operator makes a call with the registered telephone number since the customer rejects the calls from the call center or the telephone number is changed, or a case where the customer is in the hospital, is applicable for performing the ATM notification. Meanwhile, in a case where all of the operators are permitted to perform the ATM notification, there is concern that the less skilled operator erroneously determines to perform the ATM notification. In order to avoid such a case, only the skillful operator may instruct the ATM notification. In addition, when the operator instructs the ATM notification, a plurality of messages which are generated by using the template DB 12e are displayed on the operator terminal 13, and then the operator may select an appropriate message among the plurality of messages. Alternatively, the operator may input the message from the operator terminal 13.

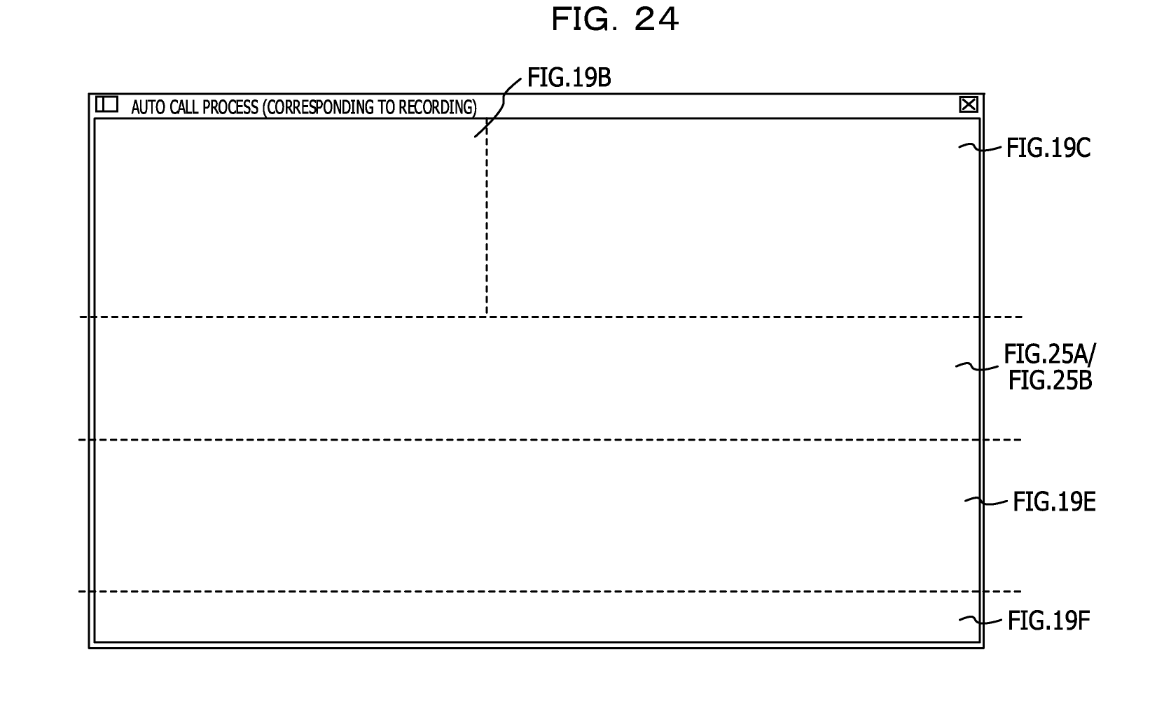

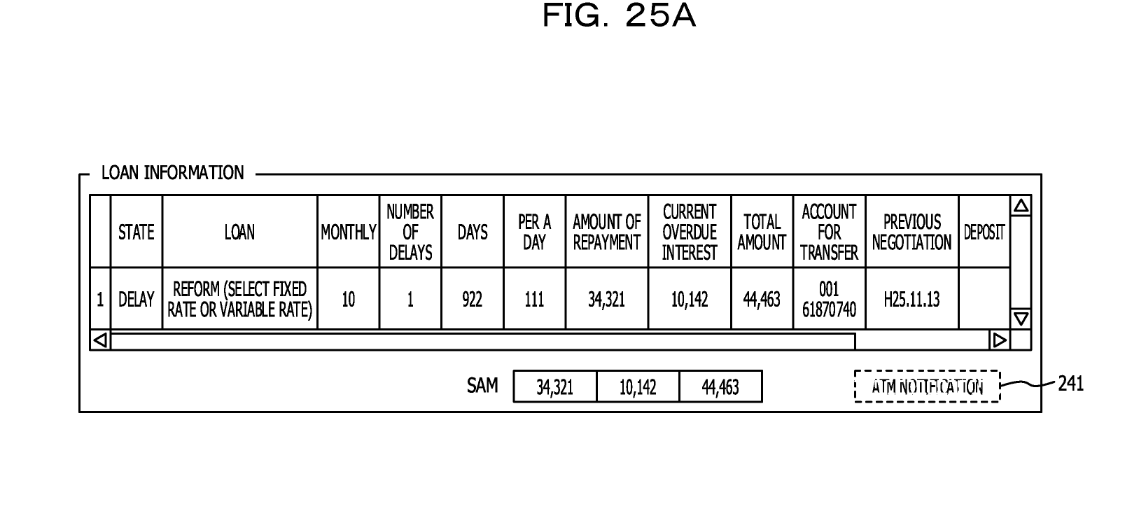

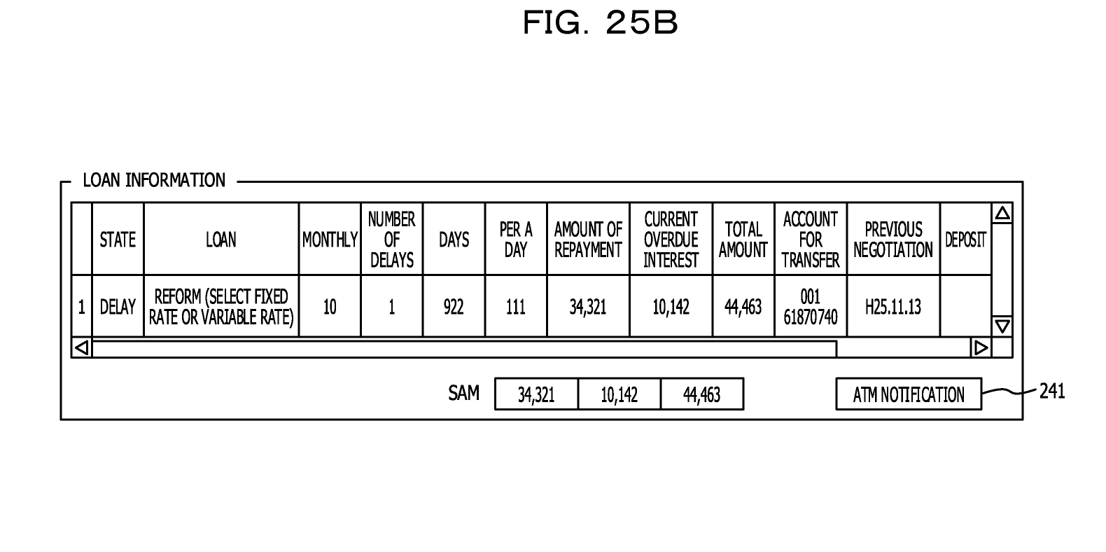

FIG. 24, FIG. 25A and FIG. 25B illustrate an example of a screen displayed on an operator terminal in a call center according to a fourth embodiment. The example of the screen in FIG. 24 also includes displays illustrated in FIGS. 19B, 19C, 19E, and 19F. FIG. 25A in FIG. 24 illustrates an example of a screen displayed with respect to the operator who is not permitted to instruct the ATM notification. FIG. 25B in FIG. 24 illustrates an example of a screen displayed with respect to the operator who is permitted to instruct the ATM notification. The difference between FIG. 25A and FIG. 25B is whether or not the “ATM notification” button 241 is available.

The following effects are accomplished in the fourth embodiment. The operator can perform the ATM notification with respect to the customer determined to be subjected to the ATM notification by the operator even though the customer is not applicable to the case set by the ATM notification determination DB 12d.

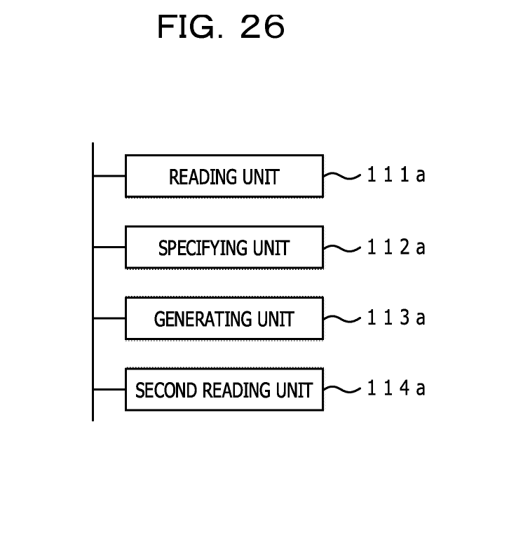

FIG. 26 illustrates an example of a functional composition of the call center server 11. FIG. 26 illustrates an example of a configuration of the call center server 11 relating to the first embodiment, the second embodiment, the third embodiment, and the fourth embodiment.

The call center server 11 includes a reading unit 111a, a specifying unit 112a, a generating unit 113a, and a second reading unit 114a. The call center server 11 operates as follows by the control program 11p being performed by the CPU 11a.

The reading unit 111a reads the history, which is associated with the identification information (the customer number+the loan account number) stored in the customer information storage unit (the list of persons in arrears), from the history storage unit (the negotiation history DB 12c). The specifying unit 112a specifies the customer who meets a predetermined condition in the content of the read history. The generating unit 113a generates notification data (message) to the specified customer. The second reading unit 114a reads customer information including an occupation and a personality of the customer which is associated with the identification information read from the reading unit.

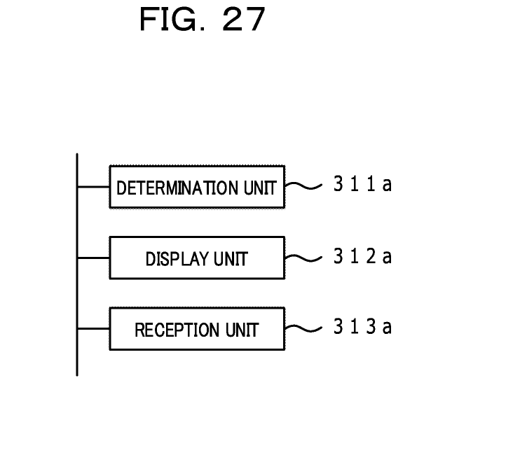

FIG. 27 illustrates an example of a functional composition of the ATM device 31. FIG. 27 illustrates an example of the configuration of the ATM device 31 relating to the first embodiment, the second embodiment, the third embodiment, and the fourth embodiment.

The ATM device 31 includes a determination unit 311a, a display unit 312a, and a reception unit 313a. By the CPU 31a which performs the control program 31p, the ATM device 31 operates as follows.

The determination unit 311a determines whether or not the notification data which is associated with the acquired identification information is stored in the notification data storage unit. The display unit 312a reads the notification data which is associated with the identification information from the notification data storage unit and displays the notification data when the determination unit 311a determines that there is the notification data. The reception unit 313a receives an input notifying of the fact that the notification data is confirmed. In addition, until the input notifying of the fact that the notification data is confirmed, the reception unit 313a does not receive any other input.

Fifth Embodiment

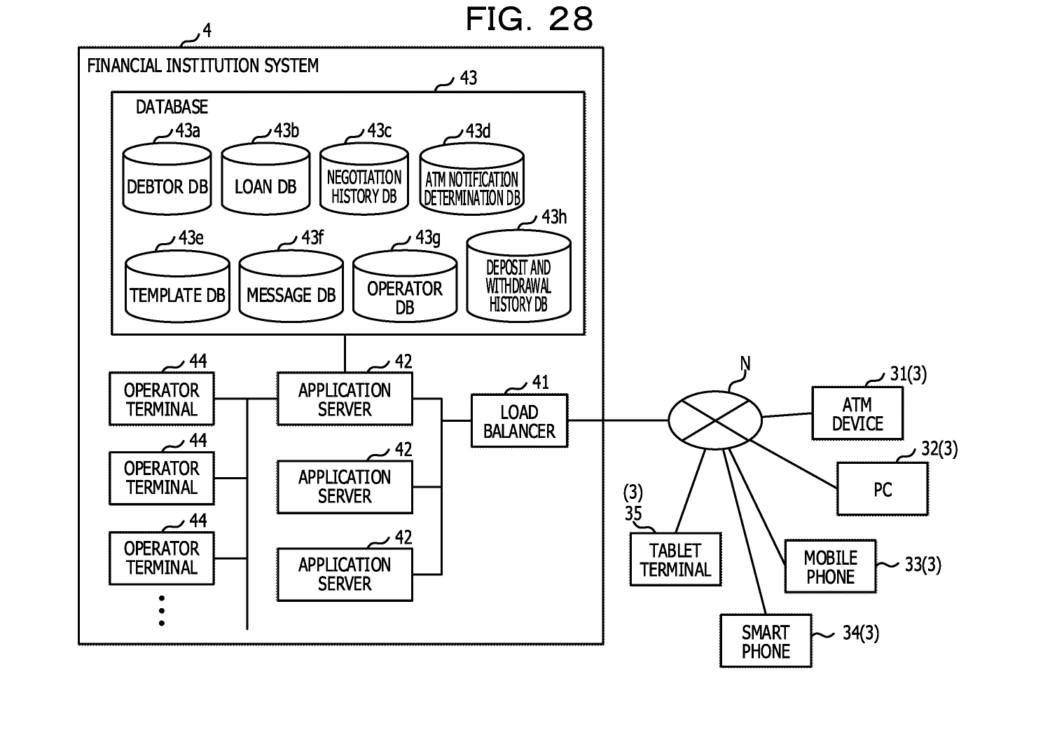

In the above described first embodiment, second embodiment, third embodiment, and fourth embodiment, the call center system 1 and the accounting system 2 are independently formed but, may be formed as a single system. FIG. 28 illustrates an example of a configuration of the payment notification system according to the fifth embodiment. The payment notification system includes the terminal device 3, a financial institution system 4 and the network N coupling the terminal device 3 and the financial institution system 4.

The financial institution system 4 includes a load balancer 41, an application server 42, a database 43, and an operator terminal 44. The load balancer 41 is a device for load distribution of a processing request from the terminal device 3. The load balancer 41 divides the processing requests from the terminal device 3 into any of the application servers 42 based on a predetermined load distribution algorithm. The application server 42 performs the processing requested from the terminal device 3. The application server 42 transmits the result of the process back to the request source of the terminal device 3. The terminal device 3, the database 43 and the operator terminal 44 are respectively the same as that in the first embodiment, the second embodiment, the third embodiment, and the fourth embodiment, therefore, the description will not be repeated.

The application server 42 serves as the aforementioned call center server 11 or the accounting server 21 according to the content of the processing requested. The configuration of hardware of the application server 42 and the information process content is the same as that of the call center server 11 or the accounting server 21 and thus the description thereof will not be repeated. Meanwhile, there are three application servers 42 in FIG. 28, but there may be two or less of the application servers 42 or four or more of the application servers 42. Further, according to a load status of the respective application servers 42, it is possible to dynamically increase or decrease the application servers 42.

The database 43 includes a debtor DB 43a, a loan DB 43b, a negotiation history DB 43c, an ATM notification determination DB 43d, a template DB 43e, a message DB 43f, an operator DB 43g, a deposit and withdrawal history DB 43h. The debtor DB 43a, the loan DB 43b, the negotiation history DB 43c, the ATM notification determination DB 43d, the template DB 43e, the message DB 43f, the operator DB 43g, and the deposit and withdrawal history DB 43h are respectively the same as the debtor DB 12a, the loan DB 12b, the negotiation history DB 12c, the ATM notification determination DB 12d, the template DB 12e, the message DB 12f, the operator DB 12g, and the deposit and withdrawal history DB 22b, therefore the description thereof will not be repeated.

In the above description, the ATM device 31 is indicated as an example of the terminal device 3; however, a PC 32, a mobile phone 33, a smart phone 34, and a tablet terminal 35 can also be an example of the terminal device 3. In that case, from the terminal device 3 to the financial institution system 4 or a system corresponding to the financial institution system 4 becomes the access by using a Web browser. Therefore, if the Web browser is completed without performing an operation that the customer confirmed the message, it is difficult to record the confirmation. With this point, the devices are different from the ATM device 31. This is because it is assumed that the transaction for withdrawing cash is performed only by the ATM device 31 by the customer using the ATM device 31. For withdrawal of the cash, since the customer is to confirm the message, if the ATM device 31 is employed as the terminal device 3, it is possible to securely record that the message is confirmed by the customer.

Other than displaying the message on the terminal device 3, printing the message content or a sentence corresponding to the message in a passbook or receipt may also be employed. The passbook belongs to the customer for the transaction and can be physical evidence for the message content being confirmed.

In addition, after the customer confirms the message, the history of the transaction performed by using the ATM device 31 is stored in the deposit and withdrawal history DB 22b of the accounting system 2. Since the deposit and withdrawal history in the accounting system 2 is a record relating to the original work of the bank, measures for tampering are sufficiently performed and the authenticity of the content is secured. Accordingly, in a case where the date and time of deposit and withdrawal history and the date and time of the message confirmation are compared with each other and if the date and time of both sides are close to each other, the reliability of the message confirmation recording is reinforced.

It is possible to advance the payment notification work by performing the ATM notification. According to the situation of the ATM notification and the skill of the operator, the operator corresponding to the person in arrears may be selected. For example, if only the same content as that in the ATM notification is used for delivery again, the content to be delivered is clear and thus even the less skilled operator is available. On the other hand, it is hard to correspond to the customer who is the person in arrears who does not deposit money regardless of the payment appointment via the ATM notification several times, the skillful operator is suitable for this case. As described above, by using a corresponding history including the ATM notification recording, it is possible for the call center server 11 to automatically assign the operator in charge of the person in arrears.

Technical features that are described in each example (configuration requirements) can be combined with each other and this combination results in forming a new technical feature. All of the disclosed embodiments here are illustrative in all respects and are not to be considered restrictive. The scope of the present disclosure which is not indicated as above described but is indicated by claims is intended to include any modifications within the meaning and range which is equivalent to the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An apparatus of outputting notification data, the apparatus comprising:
a first memory configured to store a history of contact with customer in association with identification information of the customer; and
a processor coupled to the memory and configured to:
read the history associated with the identification information from the first memory,
specify the customer who meets a predetermined condition in the content of the read history, and
generate notification data to the specified customer.

2. The apparatus according to claim 1,
wherein the predetermined condition is that a history which includes information indicating that contact with the customer is not available is in succession a predetermined number of times.

3. The apparatus according to claim 1, further comprising:
a second memory configured to store a model of the notification data,
wherein the processor is configured to:
select the model from the second memory based on the read history to read the model, and
generate the notification data by using the read model.

4. The apparatus according to claim 3,
wherein the history includes a generating history of the notification data generated, and
wherein the processor is configured to select the model based on the generating history included in the read history.

5. The apparatus according to claim 1, wherein the processor is configured to:
obtain customer information including an occupation and a personality of the customer which is associated with the identification information, and
specify the customer based on the obtained customer information and the history.

6. A method of outputting notification data executed by a processor, comprising:
reading identification information of customer;
reading a history which is associated with the read identification information;
specifying the customer who meets a predetermined condition in the content of the read history; and
generating the notification data to the specified customer.

7. The method according to claim 6,
wherein the predetermined condition is that a history which includes information indicating that contact with the customer is not available is in succession a predetermined number of times.

8. The method according to claim 6, further comprising:
a second memory configured to store a plurality of models of the notification data,
selecting the model from the plurality of models based on the read history, and
generating the notification data by using the selected model.

9. The method according to claim 8, wherein
the history includes a generating history of the notification data generated, and
the selecting selects the model based on the generating history included in the read history.

10. The method according to claim 6, further comprising:
obtaining customer information including an occupation and a personality of the customer which is associated with the identification information, and
wherein the specifying specifies the customer based on the obtained customer information and the history.

11. A system comprising:
a first processing apparatus configured to specify a customer and generate notification data to the specified customer;
a storage device configured to store the notification data generated by the first processing apparatus in association with identification information;
a second processing apparatus including a memory and a processor coupled to the memory; and
a display device including a display,
wherein the processor of the second apparatus is configured to:
determine whether a first notification data which is associated with an acquired identification information is stored in the storage device, and
read the first notification data from the storage device when the first notification data is stored,
wherein the display device is configured to display the first notification data,
wherein the processor of the second apparatus is configured to receive no operations other than operations with respect to a response operation with respect to the first notification data until the response operation is received after the first notification data is displayed on the display.

12. A device comprising:
a display device including a display; and
a processor coupled to the display device and configured to:
determine whether or not there is notification data which is associated with acquired identification information,
acquire the notification data when it is determined that there is the notification data,
display the notification data on the display, and
control the display to receive no operations other than operations with respect to a response operation with respect to the first notification data until the response operation is received after the first notification data is displayed on the display.

13. A method executed by a processor, comprising:
determining whether or not there is notification data which is associated with acquired identification information;
acquiring the notification data when it is determined that there is the notification data;
displaying the acquired notification data; and
until an input indicating the notification data is confirmed is received, not receiving input other than the input.

14. A terminal device comprising:
a memory and;
a processor coupled to the memory and configured to execute a process comprising:
obtaining identification information of a user, and
displaying information on a display apparatus of the terminal device, the information being corresponding to a history information on communication with the user, the information being different from one user to another.

15. The terminal device according to claim 14, wherein
the information is different from one attribute information of a user to another.

16. The terminal device according to claim 14, wherein the process further comprising:
receiving operation by the user in response to the displaying the information; and
recording information on the operation in the history information.

17. The terminal device according to claim 14, wherein
the obtaining obtains the identification information recorded in a recording medium received from the user.

18. The terminal device according to claim 14, wherein
the displaying displays the information to press the user for payment.

19. A method of displaying information on a display apparatus, the method comprising:
obtaining identification information of a user; and
displaying, using a processor, information on the display apparatus, the information being corresponding to a history information on communication with the user, the information being different from one user to another.

20. A non-transitory computer-readable storage medium storing a program that causes a computer to execute a process, the process comprising:
obtaining identification information of a user; and
displaying information on a display apparatus of a terminal device, the information being corresponding to a history information on communication with the user, the information being different from one user to another.
